(19) United States
(12) Patent Application Publication
(10) Pub. No.: US 2012/0307176 A1
(43) Pub. Date: Dec. 6, 2012

(54) LIQUID CRYSTAL DEVICE, PROJECTION TYPE DISPLAY DEVICE, AND ELECTRONIC APPARATUS

(75) Inventor: Takaaki Tanaka, Toshima-ku (JP)

(73) Assignee: Seiko Epson Corporation, Tokyo (JP)

(21) Appl. No.: 13/478,453

(22) Filed: May 23, 2012

(30) Foreign Application Priority Data
May 30, 2011 (JP) 2011-120046

(51) Int. Cl. G02F 1/1335; G02F 1/1343

(52) U.S. Cl. 349/61; 349/139

(57) ABSTRACT

The polarities of pixel electrodes and a common electrode are inverted and a first electrode and a second electrode on an element substrate side are driven during a first period and a second period. At this time, the polarity of the first electrode with respect to a third electrode on an opposing substrate side is the opposite to the polarity of the pixel electrodes with respect to the common electrode, and the polarity of the second electrode with respect to the third electrode on the opposing substrate side is the same as the polarity of the pixel electrodes with respect to the common electrode.

### BACKGROUND

1. Technical Field

The present invention relates to a liquid crystal device in which a liquid crystal layer is retained between a pair of substrates, a projection type display device that uses the liquid crystal device as a light valve, and an electronic apparatus.

2. Related Art

With a liquid crystal device, an element substrate on which an image display region in which a plurality of pixel electrodes are arranged on one face side is provided and an opposing substrate on which a common electrode is provided to which a common potential is applied are pasted together by a sealing material, and a liquid crystal layer is held within a region that is surrounded by the sealing material between the element substrate and the opposing substrate. With such a liquid crystal device, if ionic impurities that are mixed in when the liquid crystal is injected or ionic impurities that are eluted from the sealing material agglomerate within the image display region as the liquid crystal device is driven, deterioration in the display quality, such as burn-in (staining) of the image, occur. Therefore, a technique of providing electrodes for trapping ionic impurities on the outside of the image display region to draw in and retain the ionic impurities at the electrodes has been proposed (refer to FIG. 1 of JP-A-2002-196355 and FIG. 3 of JP-A-2008-58497).

For example, a technique of drawing in and retaining ionic impurities at a first electrode and a second electrode by generating a vertical electric field by applying a direct current voltage between the first electrode for trapping ionic impurities which is formed to surround the image display region on the element substrate and the second electrode for trapping ionic impurities which is provided on the opposing substrate side is proposed in FIG. 1 of JP-A-2002-196355. Further, a technique of providing comb-shaped first and second electrodes for trapping ionic impurities to surround the perimeter of the image display region, applying different potentials to the first and second electrodes, and inverting the polarities of the potentials that are applied to the first and second electrodes for every frame is proposed in FIG. 3 of JP-A-2008-58497. According to such a technique, since a lateral electric field is generated between the first and second electrodes, ionic impurities can be drawn in and retained at the first and second electrodes.

However, with a configuration of drawing in ionic impurities to the first and second electrodes by a direct current voltage that is applied between the first electrode on the element substrate side and the second electrode on the opposing substrate side as with the configuration described in FIG. 1 of JP-A-2002-196355, the capability of drawing in and retaining the ionic impurities is low. Further, in a case when a driving method of inverting the polarities of the potential that are applied to the pixel electrodes is adopted, there is a problem that the ionic impurities that are drawn in to the first and second electrodes are drawn in once again to the pixel electrodes.

Further, since the configuration described in FIG. 3 of JP-A-2008-58497 is a configuration in which the ionic impurities are merely retained between the first and second electrodes by driving the comb-shaped first and second electrodes for trapping ionic impurities that are provided to surround the perimeter of the image display region by an alternating current, the amount of ionic impurities that are retained is small. Moreover, as can be seen by comparing FIGS. 3 and 4 of JP-A-2002-196355, since the potential that is applied to the first electrode that is in the vicinity of the pixel electrodes out of the first and second electrodes has the same polarity as the potential that is applied to the pixel electrodes, the capability of ejecting ionic impurities from the inside to the outside of the image display region is low.

### SUMMARY

An advantage of some aspects of the invention is to provide a liquid crystal display device in which a deterioration in the display quality due to the agglomeration of ionic impurities within the image display region does not easily occur, a projection type display device that includes the liquid crystal device, and an electronic apparatus are provided.

According to an aspect of the invention, there is provided a liquid crystal device including an element substrate on which pixel electrodes are provided in an image display region; an opposing substrate that is provided to oppose the element substrate; a sealing material that pastes together the element substrate and the opposing substrate; and a liquid crystal layer that is held in a region that is surrounded by the sealing material between the element substrate and the opposing substrate, wherein the element substrate includes a first electrode that is provided between the image display region and the sealing material and a second electrode that is provided between the first electrode and the sealing material, the opposing substrate includes a common electrode that is provided on the image display region and a region that opposes the first electrode and the second electrode, wherein a first period of driving the liquid crystal layer under the condition that the potential of the pixel electrodes is higher than the potential of the common electrode and a second period of driving the liquid crystal layer under the condition that the potential of the pixel electrodes is lower than the potential of the common electrode are alternately provided, a potential that is lower than the potential of the common electrode is applied to the first electrode and a potential that is higher than the potential of the common electrode is applied to the second electrode during at least a portion the first period, and a potential that is higher than the potential of the common electrode is applied to the first electrode and a potential that is lower than the potential of the common electrode is applied to the second electrode during at least a portion the second period.

An inversion driving method is adopted in the invention, wherein the polarities of the pixel electrodes and the common electrode are inverted during the first and second periods, and the first and second electrodes are driven according to such inversion driving. At this time, the polarity of the first electrode when the common electrode is the reference is the opposite to the polarity of the pixel electrodes, and the polarity of the second electrode is the same as the polarity of the pixel electrodes. That is, the polarities between the element substrate side and the opposing substrate side are inverted for every region from the image display region toward the outside. Ionic impurities within the image display region are therefore trapped by the polarities between the element substrate and the opposing substrate, and are efficiently ejected from the inside to the outside of the image display region by the flow of the liquid crystal layer due to the oscillation of the liquid crystal molecules. Further, the ionic impurities that are ejected to the outside of the image display region move in a direction away from the image display region. Therefore, according to the invention, since the ionic impurities do not easily agglomerate within the image display region, a deterioration in the display quality caused by such agglomeration does not easily occur.

It is preferable that during the first period, after a potential that is lower than the potential of the common electrode is applied to the first electrode and a potential that is higher than the potential of the common electrode is applied to the second electrode, the same potential as the potential of the common electrode be applied to the first and second electrodes, and during the second period, after a potential that is higher than the potential of the common electrode is applied to the first electrode and a potential that is lower than the potential of the common electrode is applied to the second electrode, the same potential as the potential of the common electrode be applied to the first and second electrodes. According to such a configuration, the process of trapping ionic impurities by the polarities between the element substrate side and the opposing substrate side, the process of releasing the electric constraint on the ionic impurities, and the process of generating a flow in the liquid crystal layer by the oscillation of liquid crystal molecules may be set as appropriate in such an order. It is therefore possible to efficiently eject the ionic impurities from the inside to the outside of the image display region and to efficiently move the ionic impurities that are ejected to the outside of the image display region in a direction away from the image display region. Therefore, since the ionic impurities do not easily agglomerate within the image display region, a deterioration in the display quality caused by such agglomeration does not easily occur.

According to another aspect of the invention, there is provided a liquid crystal device including: an element substrate on which pixel electrodes are provided in an image display region; an opposing substrate on which a common electrode is provided in the image display region; a sealing material that pastes together the element substrate and the opposing substrate; and a liquid crystal layer that is held in a region that is surrounded by the sealing material between the element substrate and the opposing substrate, wherein the element substrate includes a first electrode that is provided between the image display region and the sealing material and a second electrode that is provided between the first electrode and the sealing material, the opposing substrate includes a third electrode that is provided in a region that opposes the first electrode and the second electrode, wherein a first period of driving the liquid crystal layer under the condition that the potential of the pixel electrodes is higher than the potential of the common electrode and a second period of driving the liquid crystal layer under the condition that the potential of the pixel electrodes is lower than the potential of the common electrode are alternately provided, a potential that is lower than the potential of the third electrode is applied to the first electrode and a potential that is higher than the potential of the third electrode is applied to the second electrode during at least a portion the first period, and a potential that is higher than the potential of the third electrode is applied to the first electrode and a potential that is lower than the potential of the third electrode is applied to the second electrode during at least a portion the second period.

An inversion driving method is adopted in the invention, wherein the polarities of the pixel electrodes and the common electrode are inverted during the first and second periods, and the first and second electrodes are driven according to such inversion driving. At this time, the polarity of the first electrode when the common electrode and the third electrode are the references is the opposite to the polarity of the pixel electrodes, and the polarity of the second electrode is the same as the polarity of the pixel electrodes. That is, the polarities between the element substrate and the opposing substrate are inverted for every region from the image display region toward the outside. Ionic impurities within the image display region are therefore trapped by the polarities between the element substrate side and the opposing substrate side, and are efficiently ejected from the inside to the outside of the image display region by the flow of the liquid crystal layer due to the oscillation of the liquid crystal molecules. Further, the ionic impurities that are ejected to the outside of the image display region move in a direction away from the image display region. Therefore, according to the invention, since the ionic impurities do not easily agglomerate within the image display region, a deterioration in the display quality caused by such agglomeration does not easily occur.

It is preferable that during the first period, after a potential that is different from the potential of the third electrode is applied to the first and second electrodes, the same potential as the potential of the third electrode be applied to the first and second electrodes, and during the second period, after a potential that is different from the potential of the third electrode is applied to the first and second electrodes, the same potential as the potential of the third electrode be applied to the first and second electrodes. According to such a configuration, the process of trapping ionic impurities by the polarities between the element substrate side and the opposing substrate side, the process of releasing the electric restraint on the ionic impurities, and the process of generating a flow in the liquid crystal layer by the oscillation of liquid crystal molecules may be set as appropriate in such an order. It is therefore possible to efficiently eject the ionic impurities from the inside to the outside of the image display region and to efficiently move the ionic impurities that are ejected to the outside of the image display region in a direction away from the image display region. Therefore, since the ionic impurities do not easily agglomerate within the image display region, a deterioration in the display quality caused by such agglomeration does not easily occur.

According to still another aspect of the invention, there is provided a liquid crystal device including an element substrate on which pixel electrodes are provided in an image display region; an opposing substrate on which a common electrode is provided in the image display region; a sealing material that pastes together the element substrate and the opposing substrate; and a liquid crystal layer that is held in a region that is surrounded by the sealing material between the element substrate and the opposing substrate, wherein the opposing substrate includes a first electrode that is provided between the image display region and the sealing material and a second electrode that is provided between the first electrode and the sealing material, the element substrate includes a third electrode that is provided in a region that opposes the first electrode and the second electrode, wherein a first period of driving the liquid crystal layer under the condition that the potential of the pixel electrodes is higher than the potential of the common electrode and a second period of driving the liquid crystal layer under the condition that the potential of the pixel electrodes is lower than the potential of the common electrode are alternately provided, a potential that is higher than the potential of the third electrode is applied to the first electrode and a potential that is lower than the potential of the third electrode is applied to the second electrode during at least a portion the first period, and a potential that is lower than the potential of the third electrode is applied to the first electrode and a potential that is higher than the potential of the third electrode is applied to the second electrode during at least a portion the second period.

An inversion driving method is adopted in the invention, wherein the polarities of the pixel electrodes and the common electrode are inverted during the first and second periods, and the first and second electrodes are driven according to such inversion driving. At this time, the polarity of the first electrode when the third electrode and the pixel electrodes are the references is the opposite to the polarity of the common electrode, and the polarity of the second electrode is the same as the polarity of the pixel electrodes. That is, the polarities between the element substrate and the opposing substrate are inverted for every region from the image display region toward the outside. Ionic impurities within the image display region are therefore trapped by the polarities between the element substrate side and the opposing substrate side, and are efficiently ejected from the inside to the outside of the image display region by the flow of the liquid crystal layer due to the oscillation of the liquid crystal molecules. Further, the ionic impurities that are ejected to the outside of the image display region move in a direction away from the image display region. Therefore, according to the invention, since the ionic impurities do not easily agglomerate within the image display region, a deterioration in the display quality caused by such agglomeration does not easily occur.

It is preferable that during the first period, after a potential that is different from the potential of the third electrode is applied to the first and second electrodes, the same potential as the potential of the third electrode be applied to the first and second electrodes, and during the second period, after a potential that is different from the potential of the third electrode is applied to the first and second electrodes, the same potential as the potential of the third electrode be applied to the first and second electrodes. According to such a configuration, the process of trapping ionic impurities by the polarities between the element substrate side and the opposing substrate side, the process of releasing the electric restraint on the ionic impurities, and the process of generating a flow in the liquid crystal layer by the oscillation of liquid crystal molecules may be set as appropriate in such an order. It is therefore possible to efficiently eject the ionic impurities from the inside to the outside of the image display region and to efficiently move the ionic impurities that are ejected to the outside of the image display region in a direction away from the image display region. Therefore, since the ionic impurities do not easily agglomerate within the image display region, a deterioration in the display quality caused by such agglomeration does not easily occur.

It is preferable that the first and second electrodes be provided at least in a corner that is positioned in a pretilt direction of the liquid crystal molecules within the liquid crystal layer out of a region between the image display region and the sealing material. According to such a configuration, while the ionic impurities naturally agglomerate in a corner of the image display region due to the flow of the liquid crystal layer caused by the oscillation of the liquid crystal molecules since the pretilt direction of the liquid crystal molecules is often set in a diagonal direction of the image display region, with the invention, since the first and second electrodes are provided in such a corner, the agglomeration of the ionic impurities within the image display region can be efficiently prevented.

It is preferable that a configuration in which the first and second electrodes are provided in only such a corner be adopted. According to such a configuration, even in a case when each of the first and second electrodes is provided alternately in plurality from the image display region to the sealing material, there is an advantage of being able to simplify the wiring for supplying power to the first and second electrodes, or the like.

It is preferable that a configuration in which each of the first and second electrodes are provided alternately in plurality from the image display region to the sealing material be adopted. According to such a configuration, the ionic impurities can be moved in a direction away from the image display region to the outside and retained there.

The invention is applied effectively in a case when inorganic orientation films are provided on the element substrate and the opposing substrate, and a nematic liquid crystal compound with negative dielectric anisotropy is used as the liquid crystal layer. Although an inorganic orientation film tends to adsorb ionic impurities, according to the invention, even in a case when an inorganic orientation film is used, the ionic impurities do not easily agglomerate within the image display region. Further, in a case when a nematic liquid crystal compound with a negative dielectric anisotropy is used as the liquid crystal layer, while the ionic impurities tend to agglomerate at a specific point since the liquid crystal molecules rotate with one point in the length direction as the center, according to the invention, the ionic impurities do not easily agglomerate within the image display region even in a case when a nematic liquid crystal compound with negative dielectric anisotropy is used.

A liquid crystal device to which the invention is applied may be used as a projection type display device, and such a projection type display device includes a light source unit that emits light to be supplied to the liquid crystal device and a projection optical system that projects light that is modulated by the liquid crystal device.

Other than a projection type display device, the projection type display device according to the invention may be applied to various electronic apparatuses.

### BRIEF DESCRIPTION OF THE DRAWINGS

The invention will be described with reference to the accompanying drawings, wherein like numbers reference like elements.

FIG. 1 is a block diagram that illustrates an electrical configuration of a liquid crystal device according to Embodiment 1 of the invention.

FIGS. 2A and 2B are explanatory diagrams of a liquid crystal panel of the liquid crystal device according to Embodiment 1 of the invention.

FIGS. 3A and 3B are explanatory diagrams of electrodes and the like that are formed on an element substrate of the liquid crystal device according to Embodiment 1 of the invention.

FIG. 4 is a plan diagram of a plurality of adjacent pixels on an element substrate that is used for the liquid crystal device according to Embodiment 1 of the invention.

FIGS. 5A and 5B are explanatory diagrams that illustrate a cross-sectional configuration of the liquid crystal device according to Embodiment 1 of the invention.

FIGS. 6A to 6C are explanatory diagrams of signals for driving pixels and for trapping ionic impurities in the liquid crystal device according to Embodiment 1 of the invention.

FIGS. 7A to 7E are explanatory diagrams that illustrate the state of trapping the ionic impurities in the liquid crystal device according to Embodiment 1 of the invention.

FIG. 8 is an explanatory diagram of electrodes and the like that are formed on the element substrate of a liquid crystal device according to Embodiment 2 of the invention.

FIG. 9 is an explanatory diagram of electrodes and the like that are formed on the element substrate of a liquid crystal device according to Embodiment 3 of the invention.

FIGS. 10A to 10D are explanatory diagrams of electrodes and the like that are formed on a liquid crystal device according to Embodiment 4 of the invention.

FIGS. 11A and 11B are outline configuration diagrams of a projection type display device that uses a liquid crystal device to which the invention is applied.

### DESCRIPTION OF EXEMPLARY EMBODIMENTS

Embodiments of the invention will be described with reference to the drawings. Here, in the drawings that are referenced in the description below, the scales of each layer and each member are different so that each layer and each member has a size that can be recognized on the drawings. Here, while the source and the drain are switched around in a case when the direction of the current that flows through a field-effect type transistor is inverted, for convenience, the side to which the pixel electrodes are connected is the drain and the side to which data lines are connected is the source in the description below. Further, when describing a layer that is formed on the element substrate, the upper layer side or the surface side refers to the opposite side (side on which the opposing substrate is positioned) of the element substrate to the side on which the substrate main body is positioned, and the lower layer side refers to the side (opposite side to the side on which the opposing substrate is positioned) of the element substrate on which the substrate main body is positioned.

### Embodiment 1

In Embodiment 1 of the invention, first, a case when a first electrode and a second electrode are provided on the element substrate side will be described.

### Electrical Configuration of Image Display Region and the Like

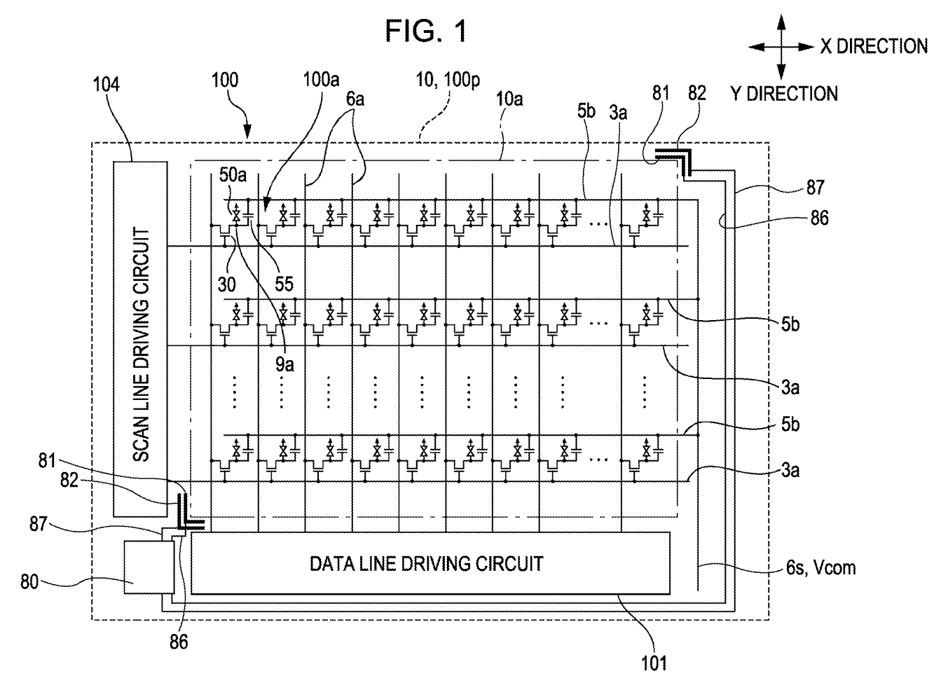

FIG. 1 is a block diagram that illustrates an electrical configuration of a liquid crystal device according to Embodiment 1 of the invention. Here, FIG. 1 is merely a block diagram that illustrates an electrical configuration, and does not illustrate wiring, the shape or the extending directions of the electrodes, the layout, or the like.

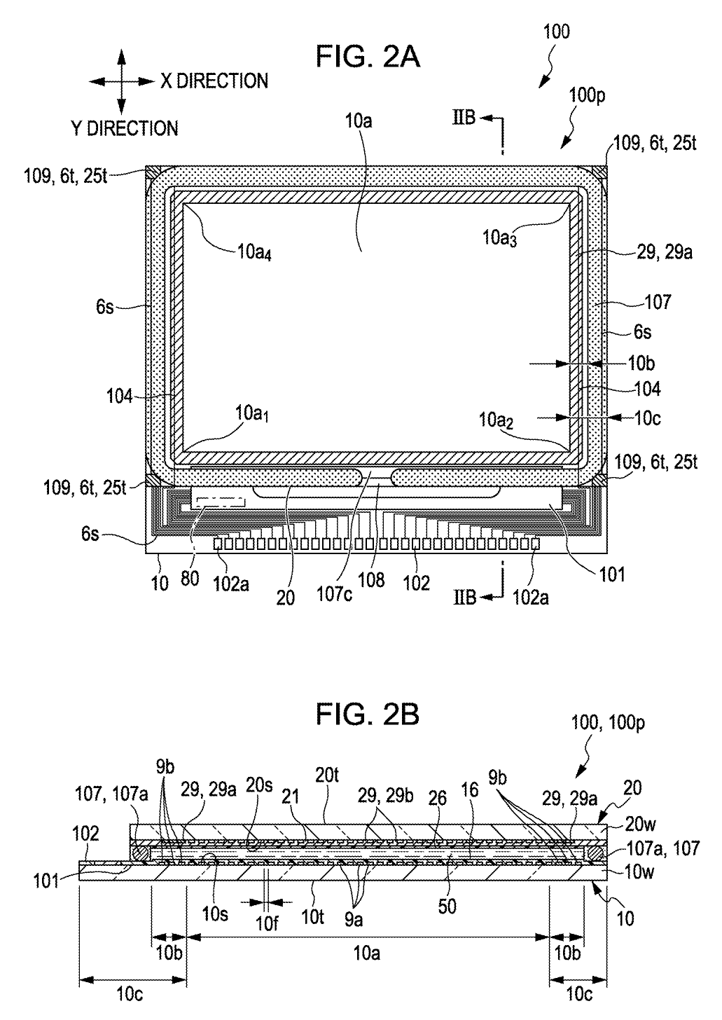

In FIG. 1, a liquid crystal device 100 includes a liquid crystal panel 100p of a TN (Twisted Nematic) mode or a VA (Vertical Alignment) mode, and the liquid crystal panel 100p includes an image display region 10a (pixel arrangement region, effective pixel region) in which a plurality of pixels 100a are arranged in a matrix form in the central region thereof. With the liquid crystal panel 100p, a plurality of data lines 6a (image signal lines) and a plurality of scan lines 3a extend vertically and horizontally on the inside of the image display region 10a on an element substrate 10 described later (refer to FIG. 2 and the like), and the pixels 100a are configured at positions that correspond to the intersecting portions thereof. A pixel transistor 30 composed of a field effect type transistor and a pixel electrode 9a described later are formed on each of the plurality of pixels 100a. The data lines 6a are electrically connected to the sources of the pixel transistors 30, the scan lines 3a are electrically connected to the gates of the pixel transistors 30, and the pixel electrodes 9a are electrically connected to the drains of the pixel transistors 30.

On the element substrate 10, a scan line driving circuit 104 and a data line driving circuit 101 (first driving circuit unit) are provided to the outer circumference side of the image display region 10a. The data line driving circuit 101 is electrically connected to each data line 6a, and sequentially supplies image signals that are supplied from the image processing circuit to each data line 6a. The scan line driving circuit 104 is electrically connected to each scan line 3a, and sequentially supplies scan signals to each scan line 3a.

For each pixel 100a, a pixel electrode 9a opposes a common electrode that is formed on an opposing substrate 20 (refer to FIGS. 2A and 2B and the like) described later via a liquid crystal layer, and configures a liquid crystal capacity 50a. Further, an accumulation capacity 55 is added to each pixel 100a to be parallel to the liquid crystal capacity 50a in order to prevent changes to the image signals that are held in the liquid crystal capacity 50a. In the embodiment, capacity lines 5b that extend across a plurality of pixels 100a are formed on the element substrate 10 to configure an accumulation capacity 55. According to the embodiment, the capacity lines 5b have conductivity with a constant potential wiring 6s to which a common potential Vcom is applied.

In the embodiment, as will be described later in detail, electrodes for trapping ionic impurities (a first electrode 81 and a second electrode 82), a trapping electrode driving circuit unit 80 (second driving circuit unit) that drives such electrodes, and electric supply lines 86 and 87 that supply driving potentials from the trapping electrode driving circuit unit 80 to the first electrode 81 and the second electrode 82 are formed on the element substrate 10 further to the outer circumference side than the image display region 10a.

### Configuration of Liquid Crystal Panel 100p and Element Substrate 10

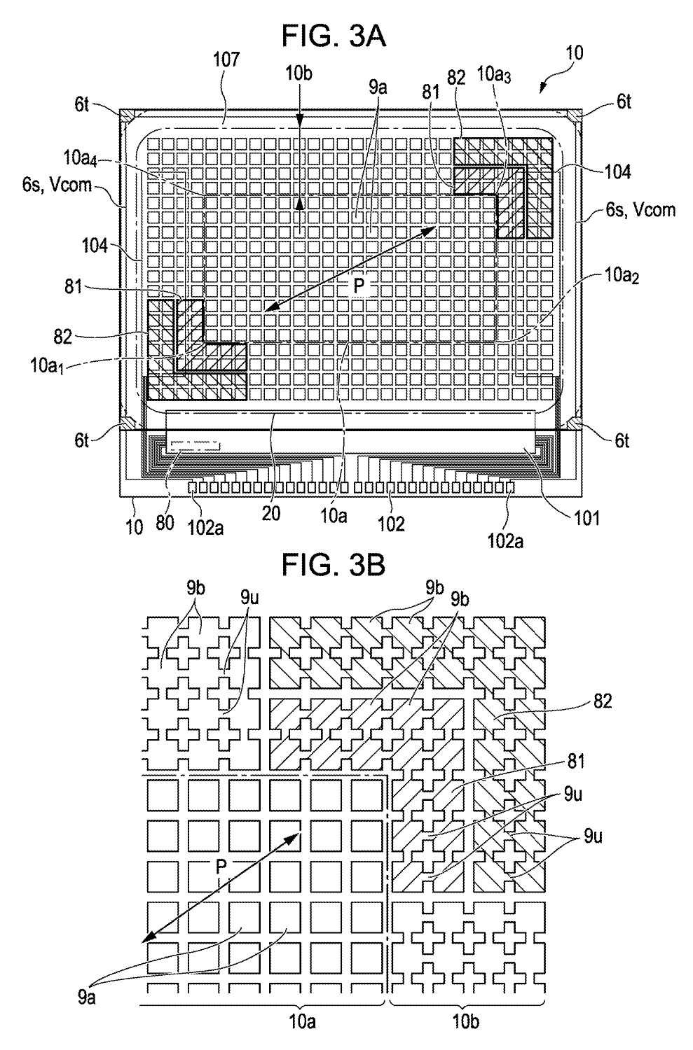

FIGS. 2A and 2B are explanatory diagrams of the liquid crystal panel 100p of the liquid crystal device 100 according to Embodiment 1 of the invention, and FIGS. 2A and 2B are respectively a plan diagram in which the liquid crystal panel 100p is seen from the side of the opposing substrate along with each constituent element and a IIB-IIB cross-sectional diagram thereof. FIGS. 3A and 3B are explanatory diagrams of electrodes and the like that are formed on the element substrate 10 of the liquid crystal device 100 according to Embodiment 1 of the invention, and FIGS. 3A and 3B are an explanatory diagram of the electrodes and the like that are formed on the entire element substrate 10 and an explanatory diagram of dummy pixel electrodes. Here, in FIGS. 3A and 3B and the like, the number and the like of the pixel electrodes 9a are reduced in the illustrations.

As illustrated in FIGS. 2A and 2B, with the liquid crystal panel 100p, the element substrate 10 and the opposing substrate 20 are pasted together by a sealing material 107 with a predetermined gap, and the sealing material 107 is provided in a frame shape along the outer rim of the opposing substrate 20. The sealing material 107 is an adhesive composed of a photocurable resin, a heat curable resin, or the like, and includes a gap material 107a such as glass fiber, glass beads, or the like for keeping the distance between both substrates a predetermined value. With the liquid crystal panel 100p, a liquid crystal layer 50 is held within a region that is surrounded by the sealing material 107 between the element substrate 10 and the opposing substrate 20. According to the embodiment, a broken portion 107c that is used as a liquid crystal injection opening is formed on the sealing material 107, and the broken portion 107c is blocked by a sealant 108 after the injection of the liquid crystal material.

As illustrated in FIGS. 2A and 2B and 3A, with the liquid crystal panel 100p, the element substrate 10 and the opposing substrate 20 are both quadrangles, and the image display region 10a described with reference to FIG. 1 is provided as a quadrangular region in the substantial center of the liquid crystal panel 100p. The sealing material 107 is also provided as substantially a quadrangle to correspond to such a shape, and the outside of the image display region 10a is a quadrangular frame-shaped outer circumference region 10c.

With the element substrate 10, the data line driving circuit 101 and a plurality of terminals 102 are formed along one side of the element substrate 10 in the outer region 10c, and the scan line driving circuit 104 is formed along a different side that is adjacent to such a side. Here, a flexible wiring substrate (not shown) is connected to the terminals 102, and various potentials and various signals are input to the element substrate 10 via the flexible wiring substrate.

Although described in detail later, out of one face 10s and another face 10t of the element substrate 10, pixel transistors 30 described with reference to FIG. 1 and the pixel electrodes 9a that are electrically connected to the pixel transistors 30 are formed in a matrix pattern on the image display region 10a on the side of the one face 10s that opposes the opposing substrate 20, and an inorganic orientation film 16 is formed on the upper layer side of the pixel electrodes 9a.

Further, on the side of the one face 10s of the element substrate 10, dummy pixel electrodes 9b that are formed at the same time as the pixel electrodes 9a are formed on a quadrangular frame-shaped surrounding region 10b that is interposed between the image display region 10a and the sealing material 107 out of the outer circumference region 10c that is further to the outside than the image display region 10a.

As illustrated in FIG. 3B, adjacent dummy pixel electrodes 9b are connected by coupling units 9u with narrow widths. The common potential Vcom is applied to the dummy pixel electrodes 9b, and the dummy pixel electrodes 9b prevent disorders in the orientation of the liquid crystal molecules at the outer circumference end portions of the image display region 10a. Further, when flattening the face on which the inorganic orientation film 16 is formed on the element substrate 10 by polishing, the dummy pixel electrodes 9b shrink the difference in the height positions of the image display region 10a and the surrounding region 10b, contributing to the flattening of the face on which the inorganic orientation film 16 is formed. Here, there may be a case when the dummy pixel electrodes 9b are floated in terms of the potential without applying a potential to the dummy pixel electrodes 9b, and even in such a case, the dummy pixel electrodes 9b shrink the difference in the height positions of the image display region 10a and the surrounding region 10b, contributing to the flattening of the face on which the inorganic orientation film 16 is formed.

In FIGS. 2A and 2B once again, a common electrode 21 is formed on the side of the one face 20s that opposes the element substrate 10 out of the one face 20s and the other face 20t of the opposing substrate 20. The common electrode 21 is formed across substantially the entire face of the opposing substrate 20 or the plurality of pixels 100a as a plurality of strip-like electrodes. According to the embodiment, the common electrode 21 is formed on substantially the entire face of the opposing substrate 20.

Further, a light blocking layer 29 is formed on the lower layer side of the common electrode 21 on the side of the one face 20s of the opposing substrate 20 and an inorganic orientation film 26 is laminated on the surface of the common electrode 21. According to the embodiment, the light blocking layer 29 is formed as a frame portion 29a that extends along the outer circumference edge of the image display region 10a. According to the embodiment, the light blocking layer 29 is also formed as a black matrix portion 29b that overlaps inter-pixel regions 10f that are interposed by adjacent pixel electrodes 9a. Here, the frame portion 29a is formed at a position that overlaps the dummy pixel electrodes 9b, and the outer circumference edge of the frame portion 29a is at a position that is separated with a gap between the outer circumference edge of the frame portion 29a and the inner circumference edge of the sealing material 107. The frame portion 29a and the sealing material 107 therefore do not overlap.

With the liquid crystal panel 100p, inter-substrate conducting electrode units 25t are formed on four corner portions on the side of the one face 20s of the opposing substrate 20 to the outside of the sealing material 107, and inter-substrate conducting electrode units 6t are formed at positions that oppose the four corners (inter-substrate conducting electrode units 25t) of the opposing substrate 20 on the side of one face 10s of the element substrate 10. According to the embodiment, the inter-substrate conducting electrode units 25t are composed of a portion of the common electrode 21. The inter-substrate conducting electrode units 6t have conductivity with the constant potential wiring 6s to which the common potential Vcom is applied, and the constant potential wiring 6s has conductivity with terminals 102a for applying a common potential out of the terminals 102. Inter-substrate conductive materials 109 that include conductive particles are placed between the inter-substrate conducting electrode units 6t and the inter-substrate conducting electrode units 25t, and the common electrode 21 of the opposing substrate 20 is electrically connected to the element substrate 10 side via the inter-substrate conducting electrode units 6t, the inter-substrate conductive materials 109, and the inter-substrate conducting electrode units 25t. The common potential Vcom is therefore applied from the side of the element substrate 10 to the common electrode 21. The sealing material 107 is provided along the outer circumference edge of the opposing substrate 20 with substantially the same width dimensions. The sealing material 107 is therefore substantially a quadrangle. However, the sealing material 107 is provided to pass through the inside to avoid the inter-substrate conducting electrode units 6t and 25t on regions that overlap the corner portions of the opposing substrate 20, and the corner portions of the sealing material 107 are substantially arc shapes.

According to the liquid crystal device 100 with such a configuration, with the embodiment, the pixel electrodes 9a and the common electrodes 21 are formed by transmissive conductive films such as ITO (Indium Tin Oxide) films or IZO (Indium Zinc Oxide) films, and the liquid crystal device 100 is a transmissive type liquid crystal device. With the liquid crystal device 100 of such a transmissive type, an image is displayed as light that is incident from the side of the opposing substrate 20 is modulated while transmitting and emitting the element substrate 10. Here, there is also a case when out of the pixel electrodes 9a and the common electrode 21, the common electrode 21 is formed of a light transmissive conductive film and the pixel electrodes 9a are formed of reflective conductive films such as aluminum films or the like, for example, and according to such a configuration, a reflective type liquid crystal device 100 can be configured. With the reflective type liquid crystal device 100, an image is displayed while light that is incident from the side of the opposing substrate 20 out of the element substrate 10 and the opposing substrate 20 is modulated while being reflected and emitted by the element substrate 10.

The liquid crystal device 100 may be used as a color display device of an electronic apparatus such as a mobile computer or a mobile phone, and in such a case, a color filter (not shown) is formed on the opposing substrate 20 or the element substrate 10. Further, with the liquid crystal device 100, a polarization film, a phase difference film, a polarization plate, or the like is placed with a predetermined orientation with respect to the liquid crystal panel 100p depending on the type of the liquid crystal layer 50 that is used or the differences between a normally white mode and a normally black mode. Further, the liquid crystal device 100 may be used as an RGB light bulb in a projection type display device (liquid crystal projector) described later. In such a case, since light of each color which is decomposed via dichroic mirrors for decomposing RGB colors is respectively incident as projection light on each liquid crystal device 100 for RGB, a color filter is not formed.

According to the embodiment, a case when the liquid crystal device 100 is a transmissive type liquid crystal device that is used as an RGB light bulb in a projection type display device described later, and the light that is incident from the opposing substrate 20 is emitted by transmitting the element substrate 10 will be mainly described. Further, according to the embodiment, a case when the liquid crystal device 100 includes the liquid crystal panel 100p of a VA mode using a nematic liquid crystal compound with negative dielectric anisotropy is used as the liquid crystal molecules of the liquid crystal layer 50 will be mainly described.

### Specific Configuration of Pixels and the Like

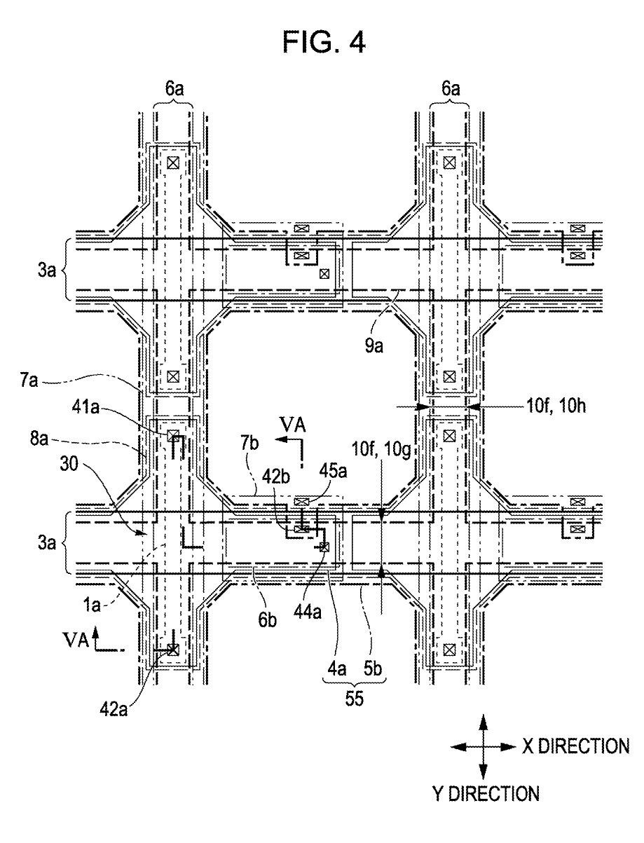

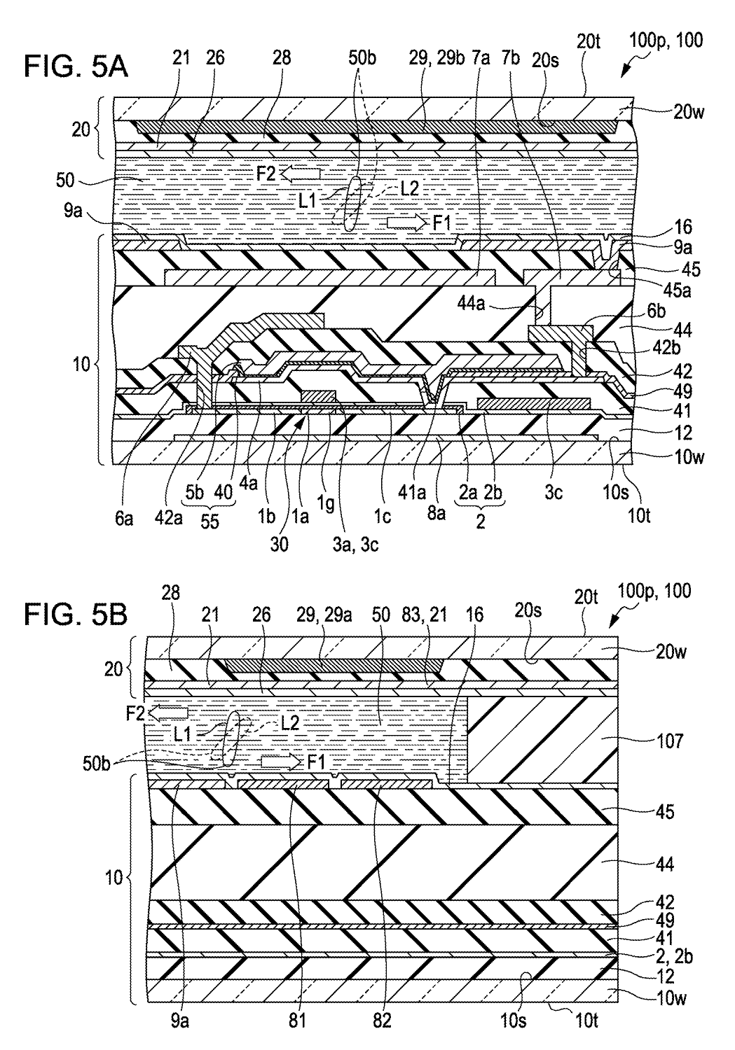

FIG. 4 is a plan diagram of a plurality of pixels that are adjacent on the element substrate 10 that is used in the liquid crystal device 100 according to Embodiment 1 of the invention. FIGS. 5A and 5B are explanatory diagrams that illustrate the cross-sectional configuration of the liquid crystal device 100 according to Embodiment 1 of the invention, and FIGS. 5A and 5B are an VA-VA and VB-VB cross-sectional diagram of the pixels that are illustrated in FIG. 4 and a cross-sectional diagram of the outer circumference region 10c. Here, in FIG. 4, each layer is illustrated as below.

Light blocking layer 8a on the lower layer side=long and thin dotted line

Semiconductor layer 1a=thin and short dotted line

Scan line 3a=thick solid line

Drain electrode 4a=thin solid line

Data line 6a and relay electrode 6b=thin dotted single chain line

Capacity line 5b=thick dotted single chain line

Light blocking layer 7a and the relay electrode 7b on the upper layer side=thin double dotted chain line

Pixel electrode 9a=thick dotted line

Further, in FIG. 4, the positions of end portions are shifted for layers in which the end portions of each overlap so that the shapes and the like of the layers are easy to see.

As illustrated in FIG. 4, a pixel electrode 9a is formed on each of a plurality of pixels 100a on the one face 10s that opposes the opposing substrate 20 on the element substrate 10, and the data lines 6a and the scan lines 3a are formed along the inter-pixel regions 10f that are interposed between adjacent pixel electrodes 9a. According to the embodiment, the inter-pixel regions 10f extend vertically and horizontally, and out of the inter-pixel regions 10f, the scan lines 3a extend linearly along first inter-pixel regions 10g that extend in an X direction (first direction), and the data lines 6a extend linearly along second inter-pixel regions 10h that extend in a Y direction (second direction). Further, the pixel transistors 30 are formed to correspond to intersections between the data lines 6a and the scan lines 3a, and according to the embodiment, the pixel transistors 30 are formed making use of the intersection regions of the data line 6a and the scan lines 3a and the vicinity thereof. The capacity lines 5b are formed on the element substrate 10, and the common potential Vcom is applied to the capacity lines 5b. According to the embodiment, the capacity lines 5b are formed in a lattice form extending to overlap the scan lines 3a and the data lines 6a. A light blocking layer 7a is formed on the upper layer side of the pixel transistors 30, and the light blocking layer 7a extends to overlap the data line 6a. A light blocking layer 8a is formed on the lower layer side of the pixel transistors 30, and the light blocking layer 8a includes a main line portion that extends linearly to overlap the scan lines 3a and a sub line portion that extends to overlap the data lines 6a at the intersection portions of the data lines 6a and the scan lines 3a.

As illustrated in FIG. 5A, the element substrate 10 is mainly configured by the pixel electrodes 9a, the pixel transistors 30 for switching the pixels, and the inorganic orientation film 16 that are formed on the substrate face on the liquid crystal layer 50 side (the one face 10s side that opposes the opposing substrate 20) of a transmissive substrate main body 10w such as a quartz substrate or a glass substrate. The opposing substrate 20 is mainly configured by a transmissive substrate main body 20w such as a quartz substrate or a glass substrate and the light blocking layer 29, the common electrode 21, and the inorganic orientation film 26 that are formed on the surface in the liquid crystal layer 50 side (the one face 20s that opposes the element substrate 10) of the substrate main body 20w.

With the element substrate 10, the light blocking layer 8a composed of a conductive film such as a conductive polysilicon film, a metal silicide film, a metallic film, or a metallic compound film on the lower layer side is formed on the one face 10s side of the substrate main body 10w. According to the embodiment, the light blocking layer 8a is composed of a light blocking film such as tungsten silicide (WSi), and prevents the occurrence of an erroneous operation in the pixel transistors 30 due to photocurrents by reflected light being incident on the semiconductor layer 1a when light that has transmitted the liquid crystal device 100 has reflected off another member. Here, there may also be a case when the light blocking layer 8a is configured as a scan line, and in such a case, a configuration in which a gate electrode 3c described later and the light blocking layer 8a have conductivity is adopted.

A transmissive insulating film 12 is formed on the upper layer side of the light blocking layer 8a on the one face 10s side of the substrate main body 10w, and the pixel transistors 30 that include the semiconductor layer 1a are formed on the surface side of the insulating film 12. According to the embodiment, the insulating film 12 is composed of a silicon oxide film (including silicate glass) such as NSG (non-silicate glass), PSG (phosphorous silicate glass), BSG (boron silicate glass), or BPSG (boron phosphorous silicate glass) or a silicon nitride film. The insulating film 12 is formed by an ordinary pressure CVD method, a reduced pressure CVD method, a plasma CVD method, or the like using silane gas (SiH₄), silane dichloride (SiCl₂H₂), TEOS (tetraethoxysilane, tetraethyl orthosilicate or Si(OC₂H₅)₄), TEB (tetra ethyl borate), TMOP (tetramethyl orthophosphate), or the like.

The pixel transistors 30 include the semiconductor layer 1a in which the long side direction faces the extending direction of the data lines 6a, and a gate electrode 3c that extends in a direction that intersects the length direction of the semiconductor layer 1a and that overlaps the central portion of the semiconductor layer 1a in the length direction, and according to the embodiment, the gate electrode 3c is composed of a portion of the scan lines 3a. The pixel transistors 30 include a transmissive gate insulating layer 2 between the semiconductor layer 1a and the gate electrode 3c. The semiconductor layer 1a includes a channel region 1g that opposes the gate electrode 3c via the gate insulating layer 2, and includes a source region 1b and a drain region 1c on both sides of the channel region 1g. According to the embodiment, the pixel transistors 30 have an LDD structure. Therefore, each of the source region 1b and the drain region 1c include a low concentration region on both sides of the channel region 1g and includes a high concentration region in an adjacent region that is the opposite side to the channel region 1g with respect to the low concentration region.

The semiconductor layer 1a is configured by a polysilicon film (polycrystalline silicon film). The gate insulating layer 2 is composed of a two-layer structure of a first gate insulating layer 2a composed of a silicon oxide film in which the semiconductor layer 1a is thermally oxidized and a second gate insulating layer 2b composed of a silicon oxide film that is formed by a reduced pressure CVD method in a high temperature condition of 700 to 900° C. The gate electrode 3c and the scan lines 3a are composed of conductive films such as a conductive polysilicon film, a metal silicide film, a metallic film, or a metallic compound film. According to the embodiment, the gate electrode 3c has a two-layered structure of a conductive polysilicon film and a tungsten silicide film.

A transmissive inter-layer insulating film 41 composed of a silicon oxide film or the like such as NSG, PSG, BSG, or BPSG is formed on the upper layer side of the gate electrode 3c, and a drain electrode 4a is formed on the upper layer of the inter-layer insulating film 41. According to the embodiment, the inter-layer insulating film 41 is composed of a silicon oxide film. The drain electrode 4a is composed of a conductive film such as a conductive polysilicon film, a metal silicide film, a metallic film, or a metallic compound film. According to the embodiment, the drain electrode 4a is composed of a titanium nitride film. The drain electrode 4a is formed so that a portion thereof overlaps the drain region 1c (pixel electrode side source drain region) of the semiconductor layer 1a, and has conductivity with the drain region 1c via a contact hole 41a that penetrates the inter-layer insulating film 41 and the gate insulating layer 2.

A transmissive etching stopper layer 49 composed of a silicon oxide film or the like and a transmissive dielectric layer 40 are formed on the upper layer side of the drain electrode 4a, and a capacity line 5b is formed on the upper layer side of the dielectric layer 40. Other than a silicon compound such as a silicon oxide film or a silicon nitride film, a dielectric layer with a high dielectric constant such as an aluminum oxide film, a titanium oxide film, a tantalum oxide film, a niobium oxide film, a hafnium oxide film, a lanthanum oxide film, or a zirconium oxide film may be used as the dielectric layer 40. The capacity line 5b is composed of a conductive film such as a conductive polysilicon film, a metal silicide film, a metallic film, or a metallic compound film. According to the embodiment, the capacity line 5b has a three-layer structure of a titanium nitride film, an aluminum film, and a titanium nitride film. Here, the capacity line 5b overlaps the drain electrode 4a via the dielectric layer 40, and configures the accumulation capacity 55.

An inter-layer insulating film 42 is formed on the upper layer side of the capacity line 5b, and the data lines 6a and the relay electrode 6b are formed on the upper layer side of the inter-layer insulation film 42 by the same conductive film. The inter-layer insulating film 42 is composed of a silicon oxide film. The data lines 6a and the relay electrode 6b are composed of a conductive film such as a conductive polysilicon film, a metal silicide film, a metallic film, or a metallic compound film. According to the embodiment, the data lines 6a and the relay electrode 6b are composed of a laminated film of two to four layers of an aluminum alloy film, a titanium nitride film, and an aluminum film. The data lines 6a have conductivity with the source region 1b (data line side source drain region) via a contact hole 42a that penetrates the inter-layer insulating film 42, the etching stopper layer 49, the inter-layer insulating film 41, and the gate insulating layer 2. The relay electrode 6b has conductivity with the drain electrode 4a via a contact hole 42b that penetrates the inter-layer insulating film 42 and the etching stopper layer 49.

A transmissive inter-layer insulating film 44 composed of a silicon oxide film or the like is formed on the upper layer side of the data lines 6a and the relay electrode 6b, and the light blocking layer 7a and a relay electrode 7b are formed by the same conductive film on the upper layer side of the inter-layer insulating film 44. The inter-layer insulating film 44 is composed of a silicon oxide film that is formed by, for example, a plasma CVD method using tetraethoxysilane and oxygen gas, a plasma CVD method using silane gas and nitrous suboxide gas, or the like, and the surface thereof is flattened. The light blocking layer 7a and the relay electrode 7b are composed of a conductive film such as a conductive polysilicon film, a metal silicide film, a metallic film, or a metallic compound film. According to the embodiment, the light blocking layer 7a and the relay electrode 7b are composed of a laminated film of two to four layers of an aluminum alloy film, a titanium nitride film, and an aluminum film. The relay electrode 7b has conductivity with the relay electrode 6b via the contact hole 44a that penetrates the inter-layer insulating film 44. The light blocking layer 7a extends to overlap the data lines 6a, and functions as a light blocking layer. Here, the light blocking layer 7a may be used as a shield layer by being made to have conductivity with the capacity line 5b.

A transmissive inter-layer insulating film 45 composed of a silicon oxide film or the like is formed on the upper layer side of the light blocking layer 7a and the relay electrode 7b, and the pixel electrodes 9a composed of a transmissive conductive film such as an ITO film are formed on the upper layer side of the inter-layer insulating film 45. According to the embodiment, the pixel electrodes 9a are composed of an ITO film. The inter-layer insulating film 45 is composed of a silicon oxide film that is formed by, for example, a plasma CVD method using tetraethoxysilane and oxygen gas, a plasma CVD method using silane gas and nitrous suboxide gas, or the like, and the surface thereof is flattened.

The pixel electrodes 9a partially overlap the relay electrode 7b, and have conductivity with the relay electrode 7b via the contact hole 45a that penetrates the inter-layer insulating film 45. As a result, the pixel electrodes 9a are electrically connected to the drain region 1c via the relay electrode 7b, the relay electrode 6b, and the drain electrode 4a.

The inorganic orientation film 16 is formed on the surfaces of the pixel electrodes 9a. According to the embodiment, the inorganic orientation film 16 is composed of an oblique deposition film (vertical tilt orientation film) such as SiOₓ (x<2), SiO₂, TiO₂, MgO, Al₂O₃, In₂O₃, Sb₂O₃, or Ta₂O₅.

### Configuration of Opposing Substrate 20

With the opposing substrate 20, the light blocking layer 29, an insulating film 28 composed of a silicon oxide film or the like, and the common electrode 21 composed of a transmissive conductive film such as an ITO film are formed on the surface on the liquid crystal layer 50 side (one side 20s that opposes the element substrate 10) of the transmissive substrate main body 20w (transmissive substrate) such as a quartz substrate or a glass substrate, and an organic orientation film 26 is formed to cover the common electrode 21. According to the embodiment, the common electrode 21 is composed of an ITO film. Similarly to the inorganic orientation film 16, the inorganic orientation film 26 is composed of an oblique deposition film (vertical tilt orientation film) such as SiOₓ (x<2), SiO₂, TiO₂, MgO, Al₂O₃, In₂O₃, Sb₂O₃, or Ta₂O₅. Such inorganic orientation films 16 and 26 have anti-parallel orientation regulating forces, and orient the nematic liquid crystal compound with negative dielectric anisotropy using the liquid crystal layer 50 with a vertical tilt orientation as liquid crystal molecules 50b are illustrated in FIGS. 5A and 5B with a solid line L1. In such a manner, the liquid crystal panel 100p is configured as a liquid crystal panel of a normally black VA mode. According to the embodiment, the pretilt direction of the liquid crystal molecules 50b is set to the direction of a diagonal line that connects two corners 10a₁ and 10a₃ that are positioned diagonally out of four corners 10a₁ to 10a₄ of the image display region 10a as illustrated by an arrow P in FIGS. 3A and 3B.

### Configuration of Surrounding Region 10b

In FIGS. 3A and 3B and 5B, L-shaped electrodes (the first electrode 81 and the second electrode 82) for trapping ionic impurities which are bent along the corners 10a₁ and 10a₃ of the image display region 10a which are positioned in the pretilt direction of the liquid crystal molecules 50b are formed in the surrounding region 10b on the side of the one face 10s of the element substrate 10. Further, the trapping electrode driving circuit unit 80 (second driving circuit unit) that drives the electrodes (the first electrode 81 and the second electrode 82) for trapping ionic impurities and the electric supply lines 86 and 87 (not shown in FIGS. 1 and 3A and 3B) that supply a driving potential from the trapping electrode driving circuit unit 80 to the first electrode 81 and the second electrode 82 are formed on the element substrate 10. According to the embodiment, since the trapping electrode driving circuit unit 80 operates in conjunction with the data line driving circuit 101, the trapping electrode driving circuit unit 80 is provided within a region in which the data line driving circuit 101 is formed. Further, a third electrode 83 for trapping ionic impurities which opposes the first electrode 81 and the second electrode 82 is formed on the opposing substrate 20. According to the embodiment, the third electrode 83 is composed of a portion of the common electrode 21, and the common potential Vcom is applied thereto.

Here, the first electrode 81 is provided on a region that is interposed between the image display region 10a and the sealing material 107 on the element substrate 10, and the second electrode 82 is provided on a region that is interposed between the first electrode 81 and the sealing material 107 on the element substrate 10. The first electrode 81 is therefore positioned in the vicinity of the image display region 10a, and the second electrode 82 is adjacent to the first electrode 81 on the outside. In configuring such a first electrode 81 and the second electrode 82, a portion of the plurality of dummy pixel electrodes 9b is used in the embodiment. More specifically, as illustrated in FIG. 3B, the dummy pixel electrodes 9b that are arranged along the corners 10a₁ and 10a₃ of the image display region 10a in the surrounding region 10b out of the plurality of dummy pixel electrodes 9b are electrically separated from the other dummy pixel electrodes 9b and used as the electrodes for trapping ionic impurities (the first electrode 81 and the second electrode 82). Further, the dummy pixel electrodes 9b that are positioned to the inside near the image display region 10a in the surrounding region 10b out of the dummy pixel electrodes 9b that are provided in the corners 10a₁ and 10a₃ of the image display region 10a are connected via the coupling units 9u and configure the first electrode 81, and the dummy pixel electrodes 9b that are positioned to the outside far from the image display region 10a are connected via the coupling unit 9u and configure the second electrode 82.

Here, although not shown, a complement type transistor circuit or the like that includes n channel type driving transistors and p channel type driving transistors is configured on the data line driving circuit 101 and the scan line driving circuit 104 described with reference to FIGS. 1 and 2A and 2B. Here, driving transistors are formed using a portion of the manufacturing process of the pixel transistors 30. Therefore, the region of the element substrate 10 in which the data line driving circuit 101 and the scan line driving circuit 104 are formed also has a cross-sectional configuration that is substantially the same as the cross-sectional configuration illustrated in FIGS. 5A and 5B.

### Ionic Impurity Trapping Operation

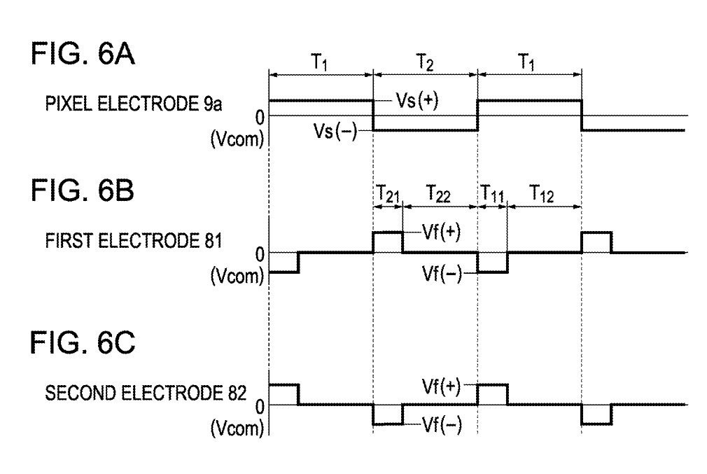

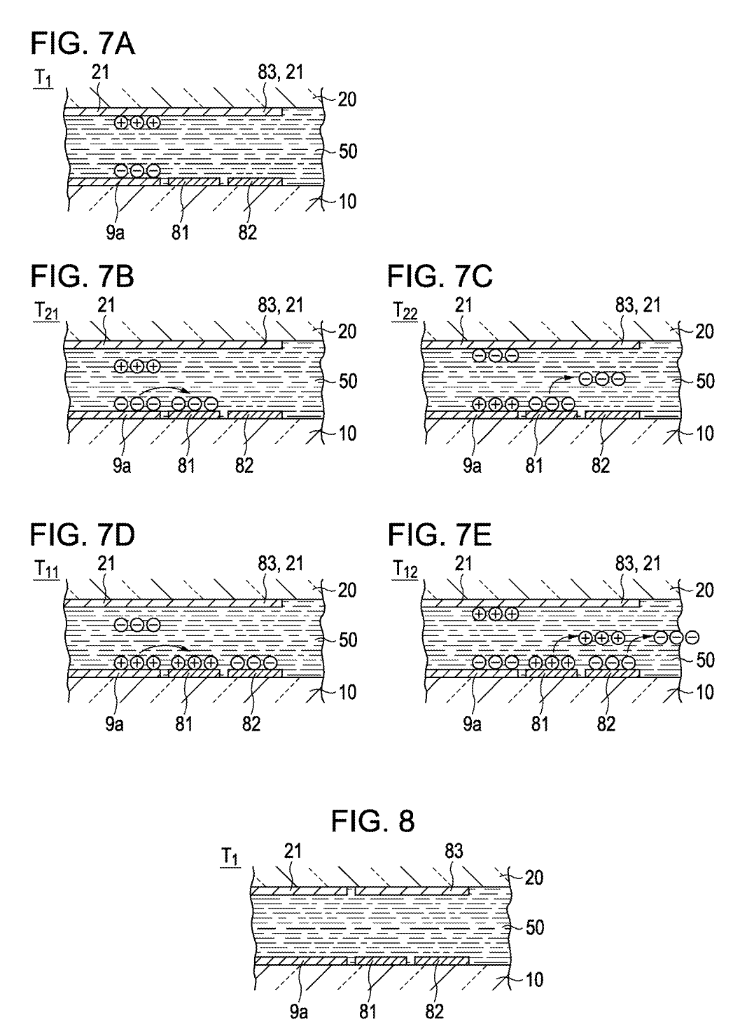

FIGS. 6A to 6C are explanatory diagrams of signals for driving pixels and for trapping ionic impurities on the liquid crystal device 100 according to Embodiment 1 of the invention, FIGS. 6A to 6C are an explanatory diagram of the potential that is applied to the pixel electrodes 9a, an explanatory diagram of the potential that is applied to the first electrode 81, and an explanatory diagram of the potential that is applied to the second electrode 82. FIGS. 7A to 7E are explanatory diagrams that illustrate the state of trapping ionic impurities on the liquid crystal device 100 according to Embodiment 1 of the invention. Here, in the embodiment, the common potential Vcom that is applied to the common electrode 21 and the third electrode 83 (a portion of the common electrode 21) is constant at 0 V.

In FIGS. 5A to 5C, the liquid crystal molecules 50b that are used in the liquid crystal layer 50 switch to the stances illustrated by the solid line L1 and a dotted line L2 when the voltage that is applied between the pixel electrodes 9a and the common electrode 21 exceeds a threshold voltage, and as a result, weak flows illustrated by arrows F1 and F2 are generated on the liquid crystal layer 50. Ionic impurities that are eluted from the sealing material 107 and the like into the liquid crystal layer 50 therefore tend to agglomerate in the corners 10a₁ and 10a₃ of the image display region 10a. Therefore, with the liquid crystal device 100 of the embodiment, the liquid crystal device 100 is operated when an image is displayed or at a stage before the liquid crystal device 100 is shipped out, and as illustrated below, in the liquid crystal layer 50, the ionic impurities that are on the inside of the image display region 10a are drawn in to the outside of the image display region 10a and retained there.

During such an operation, as illustrated in FIG. 6A, the data line driving circuit 101 (first driving circuit unit) inverts the polarity of an image signal that is supplied to the pixel electrodes 9a for every frame. More specifically, the data line driving circuit 101 alternately executes a first period T₁ of driving the pixel electrodes 9a by an image signal of a potential Vs(+) that is higher than the common potential Vcom that is applied to the common electrode 21, and a second first period T₂ of driving the pixel electrodes 9a by an image signal of a potential Vs(−) that is lower than the common potential Vcom. According to the embodiment, the potential Vs(+) is shown to be +5 V, and the potential Vs(−) is −5 V.

Along with such an operation, the trapping electrode driving circuit unit 80 supplies the first driving potential to the first electrode 81 and supplies the second driving potential to the second electrode 82 as illustrated in FIGS. 6B and 6C. Here, during at least a portion the first period T₁, the trapping electrode driving circuit unit 80 supplies a potential Vf(−) that is lower than the common potential Vcom as the first driving potential to the first electrode 81, and supplies a potential Vf(+) that is higher than the common potential Vcom as the second driving signal to the second electrode 82. Further, during at least a portion the second period T₂, the potential Vf(+) that is higher than the common potential Vcom as the first driving potential is supplied to the first electrode 81, and the potential Vf(−) that is lower than the common potential Vcom as the second driving signal is supplied to the second electrode 82. Values that exceed the threshold voltage of the liquid crystal material are set as the potentials Vf(+) and Vf(−), and according to the embodiment, the potential Vf(+) is, for example, +5 V, and the potential Vf(−) is, for example, −5 V.

Here, during a portion of an initial portion T₁₁ of the first period T₁, the trapping electrode driving circuit unit 80 supplies the potential Vf(−) that is lower than the common potential Vcom as the first driving potential to the first electrode, supplies the potential Vf(+) that is higher than the common potential Vcom as the second driving potential to the second electrode 82, and during the remaining period T₁₂ of the first period T₁ which follows, supplies the same potential as the common potential Vcom as the first driving potential and the second driving potential to the first electrode 81 and the second electrode 82. Further, during a portion of an initial portion T₂₁ of the second period T₂, the trapping electrode driving circuit unit 80 supplies the potential Vf(+) that is higher than the common potential Vcom as the first driving potential to the first electrode 81, supplies the potential Vf(−) that is lower than the common potential Vcom as the second driving potential to the second electrode 82, and during the remaining period T₂₂ of the second period T₂ which follows, supplies the same potential as the common potential Vcom as the first driving potential and the second driving potential to the first electrode 81 and the second electrode 82.

Therefore, the polarities on the element substrate 10 side and the opposing substrate 20 side during the first period T₁ and the second period T₂ are as below.

Period T₁₁ of the First Period T₁

The pixel electrodes 9a of the element substrate 10>the common electrode 21 of the opposing substrate 20

The first electrode 81 of the element substrate 10<the third electrode 83 of the opposing substrate 20

The second electrode 82 of the element substrate 10>the third electrode 83 of the opposing substrate 20

Period T₁₂ of the First Period T₁

The pixel electrodes 9a of the element substrate 10>the common electrode 21 of the opposing substrate 20

The first electrode 81 of the element substrate 10=the third electrode 83 of the opposing substrate 20

The second electrode 82 of the element substrate 10=the third electrode 83 of the opposing substrate 20

Period T₂₁ of the Second Period T₂

The pixel electrodes 9a of the element substrate 10<the common electrode 21 of the opposing substrate 20

The first electrode 81 of the element substrate 10>the third electrode 83 of the opposing substrate 20

The second electrode 82 of the element substrate 10<the third electrode 83 of the opposing substrate 20

Period T₂₂ of the Second Period T₂

The pixel electrodes 9a of the element substrate 10<the common electrode 21 of the opposing substrate 20

The first electrode 81 of the element substrate 10=the third electrode 83 of the opposing substrate 20

The second electrode 82 of the element substrate 10=the third electrode 83 of the opposing substrate 20

According to such a configuration, since the positive potential Vs(+) is first applied to the pixel electrodes 9a during the first period T₁, as illustrated in FIG. 7A, ionic impurities with negative polarity gather around the pixel electrodes 9a.

Next, when the polarity of the potential that is applied to the pixel electrodes 9a is switched and the positive potential Vf(+) is applied to the first electrode 81 during the initial period T₂₁ of the second period T₂, as illustrated in FIG. 7B, the ionic impurities that have gathered around the pixel electrodes 9a move to the first electrode 81. Here, the potential Vf(+) that is applied is a potential that exceeds the threshold value of the liquid crystal molecules 50b. Therefore, when the common potential Vcom is applied to the first electrode 81 during the period T₂₂ that follows, as illustrated in FIG. 7C, the ionic impurities with negative polarity that have been hitherto electrically constrained by the first electrode 81 are released from the constraint by the potential. Further, the ionic impurities with negative polarity move to the side of the second electrode 82 along the flow of the liquid crystal layer 50 which is induced by the oscillation of the liquid crystal molecules 50b.

Next, when the positive potential Vf(+) is applied to the second electrode 82 during the initial period T₁₁ of the first period T₁, as illustrated in FIG. 7D, the ionic impurities with negative polarity that have moved to the side of the second electrode 82 are constrained by the second electrode 82, and during the period T₂₂ that follows, as illustrated in FIG. 7E, the ionic impurities with negative polarity that have been constrained by the potential of the second electrode 82 are released from the constraint by the potential and emitted further to the outside beyond the second electrode 82 along with the flow of the liquid crystal layer 50 which is induced by the oscillation of the liquid crystal molecules 50b.

When the first period T₁ and the second period T₂ described above are thereafter repeated, the ionic impurities that have been present on the inside of the image display region 10a in the liquid crystal layer 50 are ejected to the outside of the image display region 10a and remain there. Here, during the period T₂₂, the ionic impurities with positive polarity gather around the pixel electrodes 9a since the potential Vs(−) with negative polarity is applied to the pixel electrodes 9a, and similarly to the ionic impurities with negative polarities, such ionic impurities with positive polarity are emitted further to the outside beyond the second electrode 82 having gone through the first electrode 81 and the second electrode 82.

### Main Effects of Embodiment

As described above, according to the liquid crystal device 100 of the embodiment, the data line driving circuit 101 (first driving circuit unit) inverts the polarities of the pixel electrodes 9a on the element substrate 10 side and the common electrode 21 on the opposing substrate 20 side during the first period T₁ and the second period T₂. Further, the trapping electrode driving circuit unit 80 (second driving circuit unit) drives the first electrode 81 and the second electrode 82 on the element substrate 10 side corresponding to such inversion driving. Here, the polarity of the first electrode 81 with respect to the third electrode 83 on the opposing substrate 20 side is the opposite to the polarity of the pixel electrodes 9a with respect to the common electrode 21, and the polarity of the second electrode 82 with respect to the third electrode 83 on the opposing substrate 20 side is the same as the polarity of the pixel electrodes 9a with respect to the common electrode 21. That is, the polarity between the element substrate 10 and the opposing substrate 20 inverts for every region from the image display region 10a toward the outside. Therefore, if the first period T₁ and the second period T₂ are repeated, the ionic impurities within the image display region 10a are sequentially trapped in each region by the polarity between the element substrate 10 and the opposing substrate 20 and efficiently ejected from the inside to the outside of the image display region 10a by the flow of the liquid crystal layer 50 which is generated due to the oscillation of the liquid crystal molecules 50b.

Further, in the first period T₁, while an image signal with the potential Vs(+) that is higher than the common potential Vcom is applied to the pixel electrodes 9a, since the potential Vs(−) that is lower than the common potential Vcom is applied to the first electrode 81, the potential difference between the first electrode 81 and the pixel electrodes 9a is large. The ionic impurities that are within the image display region 10a are therefore efficiently ejected from the inside to the outside of the image display region 10a. Further, similarly to the first period T₁, the ionic impurities within the image display region 10a are also efficiently ejected from the inside to the outside of the image display region 10a during the second period T₂.

Moreover, according to the embodiment, the trapping electrode driving circuit unit 80 supplies the potential Vf(−) that is lower than the common potential Vcom to the first electrode 81 and supplies the potential Vf(+) that is higher than the common potential Vcom to the second electrode 82 during the portion of the period T₁₁ of the first period T₁, and supplies the same potential as the common potential Vcom (the common potential Vcom=0 V) to the first electrode 81 and the second electrode 82 during the remaining period T₁₂ of the first period T₁ which follows. Further, the trapping electrode driving circuit unit 80 supplies the potential Vf(+) that is higher than the common potential Vcom to the first electrode 81 and supplies the potential Vf(−) that is lower than the common potential Vcom to the second electrode 82 during the portion of the period T₂₁ of the second period T₂, and supplies the same potential as the common potential Vcom (the common potential Vcom=0 V) to the first electrode 81 and the second electrode 82 during the remaining period T₂₂ of the second period T₂ which follows. It is therefore possible to appropriately set the process of trapping the ionic impurities by the polarity between the element substrate 10 side and the opposing substrate 20 side, the process of releasing the electrical constraint on the ionic impurities, and the process of generating a flow in the liquid crystal layer 50 by the oscillation of the liquid crystal molecules 50b in such an order. Therefore, since the ionic impurities are efficiently ejected from the inside to the outside of the image display region 10a, the ionic impurities tend not to agglomerate in the image display region 10a. A deterioration in the display quality due to the agglomeration in the ionic impurities therefore does not easily occur.

In particular, in the case of the liquid crystal device 100 of a VA mode, while ionic impurities tend to be unevenly distributed in a diagonal that corresponds to the orientation of the pretilt due to the flow of the liquid crystal layer 50 when the stance of the liquid crystal molecules 50b switches, the ionic impurities are efficiently ejected from the inside to the outside of the image display region 10a using the flow of the liquid crystal layer 50 effectively. Therefore, according to the embodiment, a deterioration in the display quality due to the agglomeration of ionic impurities does not easily occur even with the liquid crystal device 100 of a VA mode.

Further, while the inorganic orientation films 16 and 26 tend to adsorb the ionic impurities, according to the embodiment, it is possible to reliably prevent the ionic impurities from agglomerating in the image display region 10a. A deterioration in the display quality due to the agglomeration of ionic impurities therefore does not easily occur.

Accordingly, when an accelerated test of performing light irradiation (3 W/cm²) on the liquid crystal device 100 of the embodiment was performed by a metal halide lamp with a temperature condition of 80° C. and the length of time until unevenness in the image was noted in the surrounding portions of the image display region 10a was evaluated, an extremely long amount of time of 2250 hours elapsed before unevenness in the display was noted in the surrounding portions of the image display region 10a. On the other hand, when the same accelerated test was performed for Reference Example 1 in which a driving potential was not supplied to the first electrode 81 and the second electrode 82, unevenness in the display in the surrounding portions of the image display region 10a was noted after 300 hours. Further, when the same accelerated test was performed for Reference Example 2 in which a direct current voltage of +5 V was supplied to the first electrode 81 and the second electrode 82, unevenness in the display in the surrounding portions of the image display region 10a was noted after 500 hours. In such a manner, it was found that according to the embodiment, a deterioration in the display quality due to the agglomeration of ionic impurities does not easily occur.

### Second Embodiment

FIG. 8 is an explanatory diagram of the electrodes and the like that are formed on a liquid crystal device 100 according to Embodiment 2 of the invention. Here, since the basic configuration of the embodiment is the same as Embodiment 1, the same symbols are given to common portions, and description thereof will be omitted.

While the third electrode 83 was configured as a portion of the common electrode 21 on the opposing substrate 20 in Embodiment 1, in the present embodiment, the third electrode 83 is configured as a separate electrode that is separated from the common electrode 21 as illustrated in FIG. 8. According to such a configuration, if the same potential is set for the third electrode 83 and the common electrode 21, the potential described with reference to FIGS. 6A to 6C may be supplied to each electrode. That is, the polarities on the element substrate 10 side and the opposing substrate 20 side during the first period T₁ and the second period T₂ are as below.

Period T₁₁ of the first period T₁

The pixel electrodes 9a of the element substrate 10
>the common electrode 21 of the opposing substrate 20

The first electrode 81 of the element substrate 10
<the third electrode 83 of the opposing substrate 20

The second electrode 82 of the element substrate 10
>the third electrode 83 of the opposing substrate 20

Period T₁₂ of the first period T₁

The pixel electrodes 9a of the element substrate 10
>the common electrode 21 of the opposing substrate 20

The first electrode 81 of the element substrate 10
=the third electrode 83 of the opposing substrate 20

The second electrode 82 of the element substrate 10
=the third electrode 83 of the opposing substrate 20

Period T₂₁ of the second period T₂

The pixel electrodes 9a of the element substrate 10
<the common electrode 21 of the opposing substrate 20

The first electrode 81 of the element substrate 10
>the third electrode 83 of the opposing substrate 20

The second electrode 82 of the element substrate 10
<the third electrode 83 of the opposing substrate 20

Period T₂₂ of the second period T₂

The pixel electrodes 9a of the element substrate 10
<the common electrode 21 of the opposing substrate 20

The first electrode 81 of the element substrate 10
=the third electrode 83 of the opposing substrate 20

The second electrode 82 of the element substrate 10
=the third electrode 83 of the opposing substrate 20

Further, different potentials may be applied to the common electrode 21 and the third electrode 83, and in such a case, the polarities on the element substrate 10 side and the opposing substrate 20 side during the first period T₁ and the second period T₂ are as below.

Period T₁₁ of the first period T₁

The pixel electrodes 9a of the element substrate 10
>the common electrode 21 of the opposing substrate 20

The first electrode 81 of the element substrate 10
<the third electrode 83 and the common electrode 21 of the opposing substrate 20

The second electrode 82 of the element substrate 10
>the third electrode 83 and the common electrode 21 of the opposing substrate 20

Period T₁₂ of the first period T₁

The pixel electrodes 9a of the element substrate 10
>the common electrode 21 of the opposing substrate 20

The first electrode 81 of the element substrate 10
=the third electrode 83 and the common electrode 21 of the opposing substrate 20

The second electrode 82 of the element substrate 10
=the third electrode 83 and the common electrode 21 of the opposing substrate 20

Period T₂₁ of the second period T₂

The pixel electrodes 9a of the element substrate 10
<the common electrode 21 of the opposing substrate 20

The first electrode 81 of the element substrate 10
>the third electrode 83 and the common electrode 21 of the opposing substrate 20

The second electrode 82 of the element substrate 10
<the third electrode 83 and the common electrode 21 of the opposing substrate 20

Period T₂₂ of the second period T₂

The pixel electrodes 9a of the element substrate 10
<the common electrode 21 of the opposing substrate 20

The first electrode 81 of the element substrate 10=the third electrode 83 and the common electrode 21 of the opposing substrate 20

The second electrode 82 of the element substrate 10
=the third electrode 83 and the common electrode 21 of the opposing substrate 20

### Third Embodiment

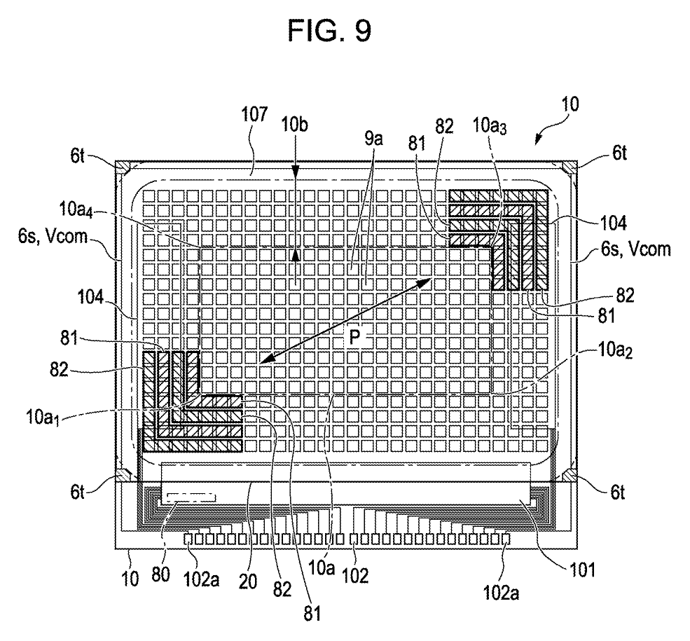

FIG. 9 is an explanatory diagram of the electrodes and the like that are formed on the element substrate 10 of a liquid crystal device 100 according to Embodiment 3 of the invention. Here, FIG. 9 is illustrated with a reduced number and the like of the pixel electrodes 9a. Further, since the basic configuration of the embodiment is the same as Embodiment 1, the same symbols are given to common portions, and description thereof will be omitted.

While one each of the first electrode 81 and the second electrode 82 were provided in the corners 10a₁ and 10a₃ in Embodiment 1, as illustrated in FIG. 9, a configuration in which each of the first electrode 81 and the second electrode 82 are alternately provided in a plurality from the image display region 10a toward the sealing material 107 may be adopted. Here, in FIG. 9, although a configuration in which two each of the first electrode 81 and the second electrode 82 are provided alternately from the image display region 10a toward the sealing material 107 is illustrated, a configuration in which three or more each of the first electrode 81 and the second electrode 82 are provided may be adopted.

In the case of such a configuration, a configuration in which the end portion on one side of the first electrodes 81 on the inside and the end portion on one side of the first electrodes 81 on the outside are connected and the end portion of the other side of the second electrodes 82 on the inside and the end portion of the other side of the first electrodes 81 on the outside are connected may be adopted.

Further, although not shown, a configuration in which the number of first electrodes 81 and the number of second electrodes 82 are different may be adopted. For example, a configuration in which two first electrodes 81 are provided and one second electrode 82 is provided, or the like may be adopted.

### Fourth Embodiment

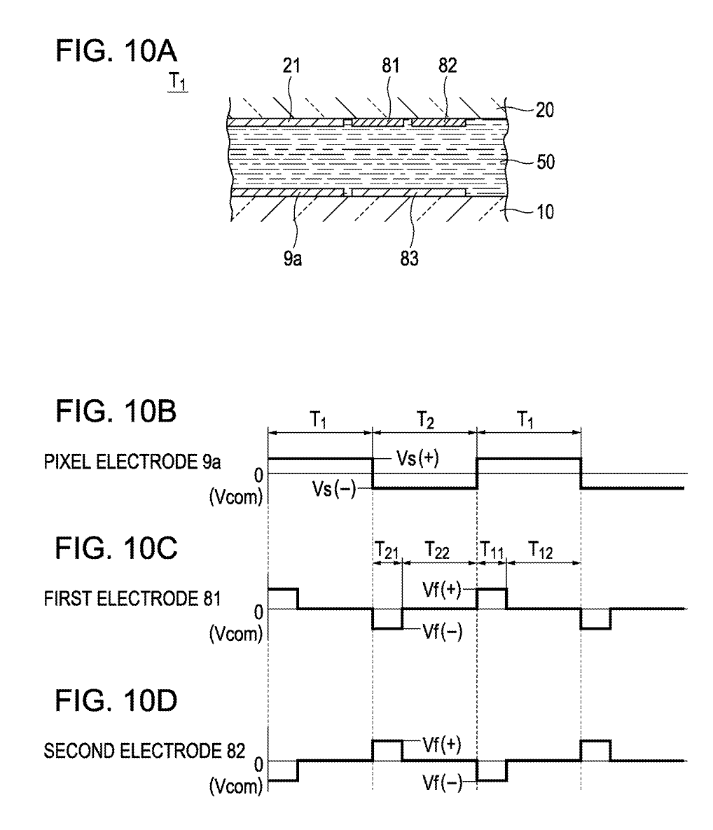

FIGS. 10A to 10D are explanatory diagrams of the electrodes and the like that are formed on a liquid crystal device 100 according to Embodiment 4 of the invention. Here, since the basic configuration of the embodiment is the same as Embodiment 1, the same symbols are given to common portions, and description thereof will be omitted.

While the first electrode 81 and the second electrode 82 are provided on the element substrate 10 and the third electrode 83 is provided on the opposing substrate 20 in Embodiments 1 and 2, as illustrated in FIG. 10A, the first electrode 81 and the second electrode 82 may be provided on the opposing substrate 20 and the third electrode 83 may be provided on the element substrate 10. Such an embodiment may be realized, for example, by configuring the third electrode 83 by the dummy pixel electrodes 9b to which the common potential Vcom is applied on the element substrate 10 side. In the case of such a configuration, as illustrated in FIGS. 10B to 10D, the potentials that are supplied to the first electrode 81 and the second electrode 82 are the reverse of the case illustrated with reference to FIGS. 6A to 6C. That is, the polarities on the element substrate 10 side and the opposing substrate 20 side during the first period T₁ and the second period T₂ are as below.

Period T₁₁ of the first period T₁

The pixel electrodes 9a of the element substrate 10>the common electrode 21 of the opposing substrate 20

The third electrode 83 of the element substrate 10<the first electrode 81 of the opposing substrate 20

The third electrode 83 of the element substrate 10>the second electrode 82 of the opposing substrate 20

Period T₁₂ of the first period T₁

The pixel electrodes 9a of the element substrate 10>the common electrode 21 of the opposing substrate 20

The third electrode 83 of the element substrate 10=the first electrode 81 of the opposing substrate 20

The third electrode 83 of the element substrate 10=the second electrode 82 of the opposing substrate 20

Period T₂₁ of the second period T₂

The pixel electrodes 9a of the element substrate 10<the common electrode 21 of the opposing substrate 20

The third electrode 83 of the element substrate 10>the first electrode 81 of the opposing substrate 20

The third electrode 83 of the element substrate 10<the second electrode 82 of the opposing substrate 20

Period T₂₂ of the second period T₂

The pixel electrodes 9a of the element substrate 10<the common electrode 21 of the opposing substrate 20

The third electrode 83 81 of the element substrate 10=the first electrode 81 of the opposing substrate 20

The third electrode 83 of the element substrate 10=the second electrode 82 of the opposing substrate 20

Further, different potentials may be applied to the common electrode 21 and the third electrode 83, and in such a case, the polarities on the element substrate 10 side and the opposing substrate 20 side during the first period T₁ and the second period T₂ are as below.

Period T₁₁ of the first period T₁

The pixel electrodes 9a of the element substrate 10>the common electrode 21 of the opposing substrate 20

The third electrode 83 of the element substrate 10<the first electrode 81 and the common electrode 21 of the opposing substrate 20

The third electrode 83 of the element substrate 10>the second electrode 82 and the common electrode 21 of the opposing substrate 20

Period T₁₂ of the first period T₁

The pixel electrodes 9a of the element substrate 10>the common electrode 21 of the opposing substrate 20

The third electrode 83 of the element substrate 10=the first electrode 81 and the common electrode 21 of the opposing substrate 20

The third electrode 83 of the element substrate 10=the second electrode 82 and the common electrode 21 of the opposing substrate 20

Period T₂₁ of the second period T₂

The pixel electrodes 9a of the element substrate 10<the common electrode 21 of the opposing substrate 20

The third electrode 83 of the element substrate 10>the first electrode 81 and the common electrode 21 of the opposing substrate 20

The third electrode 83 of the element substrate 10<the second electrode 82 and the common electrode 21 of the opposing substrate 20

Period T₂₂ of the second period T₂

The pixel electrodes 9a of the element substrate 10<the common electrode 21 of the opposing substrate 20

The third electrode 83 of the element substrate 10=the first electrode 81 and the common electrode 21 of the opposing substrate 20

The third electrode 83 of the element substrate 10=the second electrode 82 and the common electrode 21 of the opposing substrate 20

### Embodiment 5

Here, one each of the first electrode 81 and the second electrode 82 was provided in the corners 10a₁ and 10a₃ of the opposing substrate 20 in Embodiment 4. However, even in a case when the first electrode 81 and the second electrode 82 are provided on the opposing substrate 20 and the third electrode 83 is provided on the element substrate 10, a configuration in which each of the first electrode 81 and the second electrode 82 is provided alternately in a plurality from the image display region 10a toward the sealing material 107 may be adopted, similar to the third embodiment.

### Other Embodiments

While the first electrode 81 and the second electrode 82 are only provided in the corners 10a₁ and 10a₃ in the embodiments described above, the first electrode 81 and the second electrode 82 may be provided to extend over the entire circumference of the image display region 10a.

While a transmissive type liquid crystal device 100 is applied to the invention in the embodiments described above, the invention may be applied to a reflective type liquid crystal device 100.

### Installation Example on Electronic Apparatus

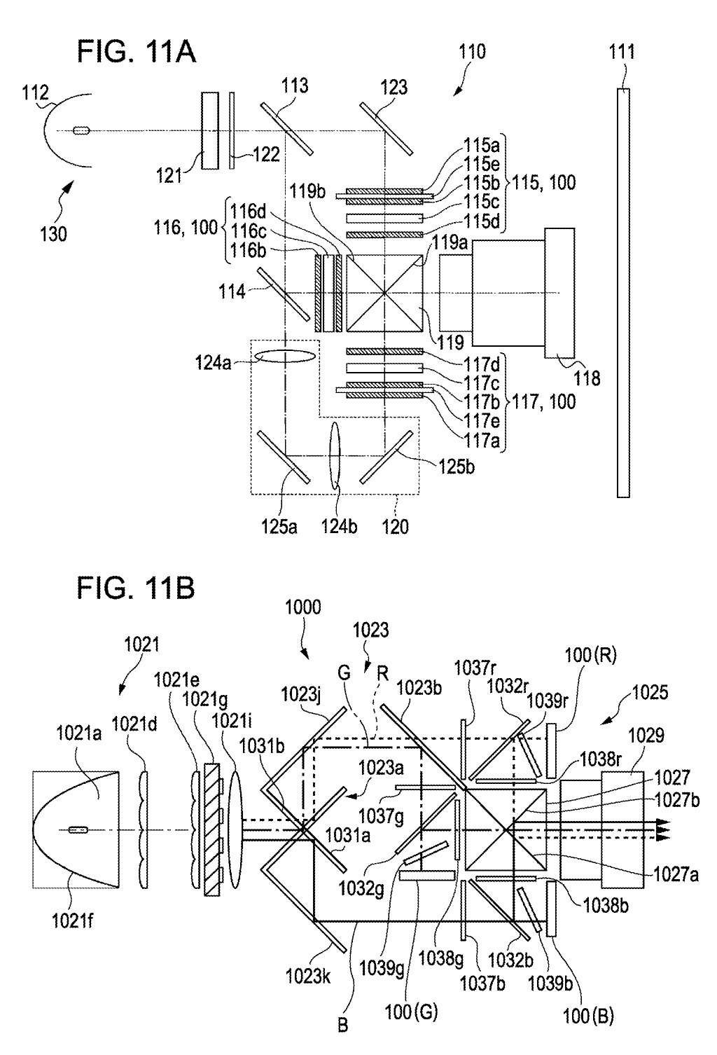

An electronic apparatus to which the liquid crystal devices 100 according to the embodiments described above are applied will be described. FIGS. 11A and 11B are outline configuration diagrams of a projection type display device that uses the liquid crystal device 100 to which the invention is applied, and FIGS. 11A and 11B are respectively an explanatory diagram of a projection type display device that uses a transmissive type liquid crystal device 100 and FIG. 11B is an explanatory diagram of a projection type display device that uses a reflective type liquid crystal device 100.

### First Example of Projection Type Display Device

A projection type display device 110 illustrated in FIG. 11A is a so-called projection type display device that irradiates light on a screen 111 that is provided on the observer side, and the reflected light is observed on the screen 111. The projection type display device 110 includes a light source unit 130 that includes a light source 112, dichroic mirrors 113 and 114, liquid crystal light bulbs 115 to 117 (liquid crystal device 100), a projection optical system 118, a cross dichroic prism 119, and a relay system 120.

The light source 112 is configured by an extra high pressure mercury lamp that supplies light that includes red light, green light, and blue light. The dichroic mirror 113 is configured to transmit the red light from the light source 112 and to reflect the green light and the blue light. Further, the dichroic mirror 114 is configured to transmit the blue light out of the green light and the blue light that are reflected by the dichroic mirror 113 and to reflect the green light. In such a manner, the dichroic mirrors 113 and 114 configure a color separation optical system that separates light that is emitted from the light source 112 into red light, green light, and blue light.

Here, an integrator 121 and a polarization conversion element 122 are placed in order from the light source 112 between the dichroic mirror 113 and the light source 112. The integrator 121 is configured to even out the illumination distribution of the light that is irradiated from the light source 112. Further, the polarization conversion element 122 is configured to cause light from the light source 112 to become polarized light with a specific vibration direction such as with s polarization light, for example.

The liquid crystal light bulb 115 is a transmissive type liquid crystal device 100 that modulates the red light that transmits the dichroic mirror 113 and that is reflected by a reflection mirror 123 according to an image signal. The liquid crystal light bulb 115 includes a λ/2 retardation plate 115a, a first polarization plate 115b, a liquid crystal panel 115c, and a second polarization plate 115d. Here, since the polarization of light of red light that is incident on the liquid crystal light bulb 115 does not change even when the dichroic mirror 113 is transmitted, the red light remains s polarization light.

The λ/2 retardation plate 115a is an optical element that converts the s polarization light that is incident on the liquid crystal light bulb 115 into p polarization light. Further, the first polarization plate 115b is a polarization plate that blocks s polarization light and transmits p polarization light. Furthermore, the liquid crystal panel 115c is configured to convert the p polarization light into s polarization light (into circular polarized light or elliptical polarized light if halftone) through modulation according to an image signal. Furthermore, the second polarization plate 115d is a polarization plate that blocks p polarization light and transmits s polarization light. Therefore, the liquid crystal light bulb 115 is configured to modulate the red light according to an image signal and to emit the modulated red light toward the cross dichroic prism 119.

Here, the λ/2 retardation plate 115a and the first polarization plate 115b are placed in a state of being in contact with a transmissive glass plate 115e that does not convert the polarization light, avoiding the λ/2 retardation plate 115a and the first polarization plate 115b becoming distorted through heating.

A liquid crystal light bulb 116 is a transmissive type liquid crystal device 100 that modulates the green light that is reflected by the dichroic mirror 114 after being reflected by the dichroic mirror 113 according to an image signal. Furthermore, similarly to the liquid crystal light bulb 115, the liquid crystal light bulb 116 includes a first polarization plate 116b, a liquid crystal panel 116c, and a second polarization plate 116d. The green light that is incident on the light crystal light bulb 116 is s polarization light that is incident after being reflected by the dichroic mirrors 113 and 114. The first polarization plate 116b is a polarization plate that blocks p polarization light and transmits s polarization light. Further, the liquid crystal panel 116c is configured to convert the s polarization light into p polarization light (into circular polarized light or elliptical polarized light if halftone) through modulation according to an image signal. Furthermore, the second polarization plate 116d is a polarization plate that blocks s polarization light and transmits p polarization light. Therefore, the liquid crystal light bulb 116 is configured to modulate the green light according to an image signal and to emit the modulated green light toward the cross dichroic prism 119.

The liquid crystal light bulb 117 is a transmissive type liquid crystal device 100 that modulates blue light that is reflected by the dichroic mirror 113 and that transmits the dichroic mirror 114 before going through the relay system 120 according to an image signal. Furthermore, similarly to the liquid crystal light bulbs 115 and 116, the liquid crystal light bulb 117 includes a λ/2 retardation plate 117a, a first polarization plate 117b, a liquid crystal panel 117c, and a second polarization plate 117d. Here, the blue light that is incident on the liquid crystal light bulb 117 is s polarization light since the blue light is reflected by the dichroic mirror 113 and transmits the dichroic mirror 114 before being reflected by two reflection mirrors 125a and 125b of the relay system 120 described later.

The λ/2 retardation plate 117a is an optical element that converts s polarization light that is incident on the liquid crystal light bulb 117 into p polarization light. Further, the first polarization plate 117b is a polarization plate that blocks s polarization light and transmits p polarization light. Furthermore, the liquid crystal panel 117c is configured to convert the p polarization light into s polarization light (into circular polarized light or elliptical polarized light if halftone) through modulation according to an image signal. Furthermore, the second polarization plate 117d is a polarization plate that blocks p polarization light and transmits s polarization light. Therefore, the liquid crystal light bulb 117 is configured to modulate the blue light according to an image signal and to emit the modulated blue light toward the cross dichroic prism 119. Here, the λ/2 retardation plate 117a and the first polarization plate 117b are placed in a state of being in contact with a glass plate 117e.

The relay system 120 includes relay lenses 124a and 124b, and the reflection mirrors 125a and 125b. The relay lenses 124a and 124b are provided to prevent the loss of light by the light path of the blue light being long. Here, the relay lens 124a is placed between the dichroic mirror 114 and the reflection mirror 125a. Further, the relay lens 124b is placed between the reflection mirrors 125a and 125b. The reflection mirror 125a is placed so that blue light that transmits the dichroic mirror 114 and that is emitted from the relay lens 124a is reflected toward the relay lens 124b. Further, the reflection mirror 125b is placed so that the blue light that is emitted from the relay lens 124b is reflected toward the liquid crystal light bulb 117.

The cross dichroic prism 119 is a color synthesis optical system in which two dichroic films 119a and 119b are placed orthogonally in an X-shape. The dichroic film 119a is a film that reflects blue light and transmits green light, and the dichroic film 119b is a film that reflects red light and transmits green light. The cross dichroic prism 119 is therefore configured to synthesize the red light, the green light, and the blue light that are respectively modulated by the liquid crystal light bulbs 115 to 117, and to emit the respective light to the projection optical system 118.

Here, light that is incident on the cross dichroic prism 119 from the liquid crystal light bulbs 115 and 117 is polarization light, and light that is incident on the cross dichroic prism 119 from the liquid crystal light bulb 116 is p polarization light. In such a manner, by the light that is incident on the cross dichroic prism 119 being polarization light of different types, the light that is incident from each liquid crystal light bulb 115 to 117 can be synthesized by the cross dichroic prism 119. Here, generally, the dichroic films 119a and 119b have excellent reflection transistor characteristics of s polarization light. Therefore, the red light and the blue light that are reflected by the dichroic films 119a and 119b are s polarization light, and the green light that transmits the dichroic films 119a and 119b is p polarization light. The projection optical system 118 includes a projection lens (not shown), and is configured to project the light that is synthesized by the cross dichroic prism 119 to the screen 111.

### Second Example of Projection Type Display Device

A projection type display device 1000 illustrated in FIG. 11B includes a light source unit 1021 that generates light source light, a color separation light guide optical system 1023 that separates the light source light that is emitted from the light source unit 1021 into the three colors of red, green, and blue, and a light modulation unit 1025 that is illuminated by the light source light of each color which is emitted by the color separation light guide optical system 1023. Further, the projection type display device 1000 includes a cross dichroic prism 1027 (synthesis optical system) that synthesizes the light image of each color which is emitted by the light modulation unit 1025 and a projection optical system 1029 that is a projection optical system for projecting the light image that has passed through the cross dichroic prism 1027 onto a screen (not shown).

With such a projection type display device 1000, the light source unit 1021 includes a light source 1021a, a pair of fly-eye optical systems 1021d and 1021e, a polarization conversion member 1021g, and a superimposing lens 1021i. According to the embodiment, the light source unit 1021 includes a reflector 1021f composed of a paraboloid, and emits parallel light. The fly-eye optical systems 1021d and 1021e are composed of a plurality of element lenses that are placed in a matrix form within a plane that is orthogonal to the system optical axis, and the light source light is divided by such element lenses and individually collected and released. The polarization conversion member 1021g converts the light source light that is emitted from the fly-eye optical system 1021e into only p polarization light components that are parallel to the drawings, for example, and supplies the converted p polarization light components to a light path downstream side optical system. The superimposing 1021i is able to uniformly superimpose and illuminate each of the plurality of liquid crystal devices 100 that are provided on the light modulation unit 1025 by converging the entirety of the light source light that has passed through the polarization conversion member 1021g as appropriate.

The color separation light guide optical system 1023 includes a cross dichroic mirror 1023a, a dichroic mirror 1023b, and reflection mirrors 1023j and 1023k. With the color separation light guide optical system 1023, the substantially white light source light from the light source unit 1021 is incident on the cross dichroic mirror 1023a. The red (R) light that is reflected by a first dichroic mirror 1031a that is one dichroic mirror that configures the cross dichroic mirror 1023a is reflected by the reflection mirror 1023j and transmits the dichroic mirror 1023b, and is incident on a liquid crystal device 100 for red light (R) still as p polarization light via an incident side polarization plate 1037r, a wire grid polarization plate 1032r that transmits p polarization light and reflects s polarization light, and an optical compensating plate 1039r.

Further, the green light (G) that is reflected by the first dichroic mirror 1031a is reflected by the reflection mirror 1023j, then also reflected by the dichroic mirror 1023b, and is incident on a liquid crystal device 100 for green (G) still as p polarization light via an incident side polarization plate 1037g, a wire grid polarization plate 1032g that transmits p polarization light and reflects polarization plate, and an optical compensating plate 1039g.

On the other hand, the blue (B) light that is reflected by a second dichroic mirror 1031b that is the other dichroic mirror that configures the cross dichroic mirror 1023a is reflected by the reflection mirror 1023k, and is incident on a liquid crystal device 100 for blue (B) still as p polarization light via an incident side polarization plate 1037b, a wire grid polarization plate 1032b that transmits p polarization light and reflects s polarization plate, and an optical compensating plate 1039b. Here, the optical compensating plates 1039r, 1039g, and 1039b optically compensate the characteristics of the liquid crystal layer by adjusting the polarization states of the incident light and emitted light to and from the light crystal device 100.

With the projection type display device 1000 that is configured in such a manner, the light of each of the three colors which is incident through the optical compensating plates 1039r, 1039g, and 1039b is modulated by each liquid crystal device 100. At such a time, the component light of s polarization light out of the modulated light that is emitted from the liquid crystal device 100 is reflected by the wire grid polarization plates 1032r, 1032g, and 1032b, and is incident on the cross dichroic prism 1027 via emission side polarization plates 1038r, 1038g, and 1038b. A first dielectric multi-layer film 1027a and a second dielectric multi-layer film 1027b that intersect in an X-shape are formed on the cross dichroic prism 1027, and the first dielectric multi-layer film 1027a on the one hand reflects R light, and the second dielectric multi-layer film 1027b on the other hand reflects B light. Therefore, light of the three colors is synthesized by the cross dichroic prism 1027 and emitted to the projection optical system 1029. Furthermore, the projection optical system 1029 projects the color light image that is synthesized by the cross dichroic prism 1027 onto a screen (not shown) by the desired magnification.

### Other Projection Type Display Devices

Here, the projection type display device may be configured so that using an LED light source or the like that emits light of each color, each of the color light that is emitted from such an LED light source is supplied to a separate liquid crystal device.

### Other Electronic Apparatuses

Other than the electronic apparatuses described above, the liquid crystal device 100 to which the invention is applied may be used as a direct view type display device on an electronic apparatus such as a mobile phone, an information mobile terminal (PDA: Personal Digital Assistants), a digital camera, a liquid crystal television, a car navigation device, a television phone, a POS terminal, or an apparatus that includes a touch panel.

This application claims priority from Japanese Patent Application No. 2011-120046 filed in the Japanese Patent Office on May 30, 2011, the entire disclosure of which is hereby incorporated by reference in its entirely.

What is claimed is:

1. A liquid crystal device comprising:
an element substrate on which pixel electrodes are provided in an image display region;
an opposing substrate that is provided to oppose the element substrate;
a sealing material that pastes together the element substrate and the opposing substrate; and
a liquid crystal layer that is held in a region that is surrounded by the sealing material between the element substrate and the opposing substrate,
wherein the element substrate includes a first electrode that is provided between the image display region and the sealing material in plain view and a second electrode that is provided between the first electrode and the sealing material in plain view,
the opposing substrate includes a common electrode that is provided a region that opposes the image display region, the first electrode and the second electrode,
wherein a first period of driving the liquid crystal layer under a condition that a potential of the pixel electrodes is higher than a potential of the common electrode and a second period of driving the liquid crystal layer under the condition that a potential of the pixel electrodes is lower than the potential of the common electrode are provided,
a potential that is lower than the potential of the common electrode is applied to the first electrode and a potential that is higher than the potential of the common electrode is applied to the second electrode during at least a portion the first period, and
a potential that is higher than the potential of the common electrode is applied to the first electrode and a potential that is lower than the potential of the common electrode is applied to the second electrode during at least a portion the second period.

2. A liquid crystal device comprising:
an element substrate on which pixel electrodes are provided in an image display region;
an opposing substrate on which a common electrode is provided in the image display region;
a sealing material that pastes together the element substrate and the opposing substrate; and
a liquid crystal layer that is held in a region that is surrounded by the sealing material between the element substrate and the opposing substrate,
wherein the element substrate includes a first electrode that is provided between the image display region and the sealing material and a second electrode that is provided between the first electrode and the sealing material,
the opposing substrate includes a third electrode that is provided in a region that opposes the first electrode and the second electrode,
wherein a first period of driving the liquid crystal layer under a condition that a potential of the pixel electrodes is higher than a potential of the common electrode and a second period of driving the liquid crystal layer under the condition that a potential of the pixel electrodes is lower than the potential of the common electrode are provided,
a potential that is lower than a potential of the third electrode is applied to the first electrode and a potential that is higher than the potential of the third electrode is applied to the second electrode during at least a portion of the first period, and
a potential that is higher than the potential of the third electrode is applied to the first electrode and a potential that is lower than the potential of the third electrode is applied to the second electrode during at least a portion the second period.

3. A liquid crystal device comprising:
an element substrate on which pixel electrodes are provided in an image display region;
an opposing substrate on which a common electrode is provided in the image display region;
a sealing material that pastes together the element substrate and the opposing substrate; and
a liquid crystal layer that is held in a region that is surrounded by the sealing material between the element substrate and the opposing substrate,
wherein the opposing substrate includes a first electrode that is provided between the image display region and the sealing material and a second electrode that is provided between the first electrode and the sealing material,
the element substrate includes a third electrode that is provided in a region that opposes the first electrode and the second electrode,
wherein a first period of driving the liquid crystal layer under a condition that a potential of the pixel electrodes is higher than a potential of the common electrode and a second period of driving the liquid crystal layer under the condition that a potential of the pixel electrodes is lower than the potential of the common electrode are provided,
a potential that is higher than a potential of the third electrode is applied to the first electrode and a potential that is lower than the potential of the third electrode is applied to the second electrode during at least a portion the first period, and
a potential that is lower than the potential of the third electrode is applied to the first electrode and a potential that is higher than the potential of the third electrode is applied to the second electrode during at least a portion the second period.

4. The liquid crystal device according to claim 1,
wherein the first period includes a third period in which a potential that is lower than the potential of the common electrode is applied to the first electrode and a potential that is higher than the potential of the common electrode is applied to the second electrode and a fourth period in which a same potential as the potential of the common electrode is applied to the first electrode and the second electrode after the third period, and
the second period includes a fifth period in which a potential that is higher than the potential of the common electrode is applied to the first electrode and a potential that is lower than the potential of the common electrode is applied to the second electrode and a sixth period in which the same potential as the potential of the common electrode is applied to the first electrode and the second electrode after the fifth period.

5. The liquid crystal device according to claim 2,
wherein the first period includes a third period in which a potential that is different from the potential of the third electrode is applied to the first electrode and the second electrode and a fourth period in which a same potential as the potential of the third electrode is applied to the first electrode and the second electrode after the third period, and
the second period includes a fifth period in which a potential that is different from the potential of the third electrode is applied to the first electrode and the second electrode and a sixth period in which the same potential as the potential of the third electrode is applied to the first electrode and the second electrode after the fifth period.

6. The liquid crystal device according to claim 4,
wherein the fourth period is longer than the third period, and
the sixth period is longer than the fourth period.

7. The liquid crystal device according to claim 1,
wherein the first electrode and the second electrode are provided in at least a corner that is positioned in a pretilt direction of liquid crystal molecules within the liquid crystal layer out of a region between the image display region and the sealing material.

8. The liquid crystal device according to claim 7,
wherein the first electrode and the second electrode are only provided in the corner.

9. The liquid crystal device according to claim 1,
wherein each of the first electrode and the second electrode is provided alternately in plurality from the image display region to the sealing material.

10. The liquid crystal device according to claim 1,
wherein an inorganic orientation film is provided on the element substrate and the opposing substrate, and
a nematic liquid crystal compound with negative dielectric anisotropy is used as the liquid crystal layer.

11. A projection type display device comprising:
the liquid crystal device according to claim 1,
a light source unit that emits light to be supplied to the liquid crystal device, and
a projection optical system that projects light that is modulated by the liquid crystal device.

12. A projection type display device comprising:
the liquid crystal device according to claim 2,
a light source unit that emits light to be supplied to the liquid crystal device, and
a projection optical system that projects light that is modulated by the liquid crystal device.

13. A projection type display device comprising:
the liquid crystal device according to claim 3,
a light source unit that emits light to be supplied to the liquid crystal device, and
a projection optical system that projects light that is modulated by the liquid crystal device.

14. An electronic apparatus comprising the liquid crystal device according to claim 1.
